(19) United States
(12) Patent Application Publication
(10) Pub. No.: US 2024/0425410 A1
(43) Pub. Date: Dec. 26, 2024

(54) CEMENT COMPOSITION COMPRISING BIOCHAR

(71) Applicant: Imam Abdulrahman Bin Faisal University, Dammam (SA)

(72) Inventors: Mukarram ZUBAIR, Dammam (SA); Muhammad Arif Aziz AHMED, Dammam (SA); Muhammad SALEEM, Dammam (SA)

(73) Assignee: Imam Abdulrahman Bin Faisal University, Dammam (SA)

(21) Appl. No.: 18/339,291

(22) Filed: Jun. 22, 2023

(51) Int. Cl. C04B 18/10; C04B 14/06; C04B 14/28; C04B 28/04

(52) U.S. Cl. CPC C04B 18/101; C04B 14/068; C04B 14/28; C04B 28/04; C04B 2103/32; C04B 2201/30; C04B 2201/50

(57) ABSTRACT

A cement composition includes a cementitious material in an amount of 10 to 40 wt. %, a date palm biochar in an amount of 0.25 to 1.5 wt. %, a fine aggregate (FA) in an amount of 20 to 85 wt. %, a coarse aggregate (CA) in an amount of 0.01 to 60 wt. %, and a plasticizer in an amount of 0.001 to 2 wt. %, each wt. % based on a total weight of the cement composition. Furthermore, the date palm biochar has a particle size in a range of 0.1 to 20 micrometers (μm) and the date palm biochar is at least one of a date palm leaves biochar (BioCl), and a date palm seeds biochar (BioCs).

### STATEMENT REGARDING PRIOR DISCLOSURE BY THE INVENTORS

Aspects of this technology are described in “Mechanical, non-destructive, and thermal characterization of biochar-based mortar composite” published in Biomass Conversion and Biorefinery, January 2023, which is incorporated herein by reference in its entirety.

### STATEMENT OF ACKNOWLEDGEMENT

This research was supported by the Researchers Supporting Project at Taif University under the project TURSP-2020/276, Saudi Arabia; and the Deanship of Scientific Research at Imam Abdulrahman Bin Faisal University under the project 2019-132-sci, the Basic and Applied Scientific Research Center at Imam Abdulrahman Bin Faisal University (IAU), Kingdom of Saudi Arabia.

### BACKGROUND

### Technical Field

The present disclosure is directed to a cement composition, particularly, to a cement composition including biochar from date palm.

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Global climate change is a major challenge that our planet is facing. The impacts of climate change are global in scope and unprecedented in scale. Some of the major impacts include shifting weather patterns that threaten food production, and rising sea levels, which increase multiple risks such as catastrophic flooding. Human actions are leaving a vast carbon footprint on our environment, and without serious efforts and a change in attitude towards climate change, the future will be more difficult and costly. Like various industries such as energy, automobile, construction industry is also looking for solutions to minimize the industry's carbon footprint. Due to unprecedented high consumption of cement and building materials of similar nature in recent decades, the carbon emission added to the environment has posed serious problems. The situation is so alarming that immediate actions are expected from the global community to deal with the situation. Thus, an essential need of the hour is to curb carbon emissions as much as possible.

One way the construction industry can reduce its carbon footprint is by introducing environmentally friendly building materials. Sustainable materials have the potential to revolutionize the construction industry by reducing its carbon footprint. One of the main building materials heavily relied on by the construction industry is cement. Cement has taken a central role in building and infrastructure development in the modern age. According to estimates, the annual production of cement exceeds 3-4 billion tons, and with the growth in city and commercial development, the amount of cement production can only increase. Such consumption and increase in production can have a significant impact on the environment in terms of the CO₂ released during cement processing and production. Thus, sustainable materials that can either reduce cement consumption or substitute the ingredients of construction substantially are the need of the hour.

Several efforts have been made to introduce naturally occurring organic ingredients to replace the cement. Industrial, domestic, and municipal waste has been applied in construction; however, such applications have been limited to the presentation of the cementing material rather than actual replacement. Unfortunately, serious efforts with the goal of reducing the carbon footprint and using such materials that can replace or reduce cement production at an industrial scale remain yet to be seen. Nevertheless, such sustainable materials that can exhibit durability, thermal and mechanical stability to be considered as a building material or a replacement for certain ingredients of the construction materials are hard to find. Several organic materials, including domestic and industrial waste, have been tested as a cement ingredient; however, such efforts have remained limited to experiments, and no serious effort has been made to come up with a replacement for cement or such building materials to curb the impact on our environment and find a long-term solution.

Thus, there is a need to provide such sustainable materials that can exhibit durability, compressibility, crack safety, and thermal and mechanical stability to be considered as a replacement for cement or major construction material. This will reduce the carbon footprint on the environment. Furthermore, the challenge is that such materials should be available in vast amounts, cost-effective, and rapid to produce. This is important to attract industries to adopt such materials.

In view of the foregoing, one objective of the present disclosure is to describe a cement composition containing date palm biochar that can overcome the aforementioned drawbacks and is economically practical for CO₂ reduction. Another objective of the present disclosure is to provide a cost-effective and rapid process for the preparation of a sustainable material using the cement composition for industrial applications. A third objective of the present disclosure is to describe a method for sequestering carbon by incorporating date palm biochar in a cement composition.

### SUMMARY

Aspects of the present invention relate to a cement composition including a cementitious material in an amount of 10 to 40 wt. % based on a total weight of the cement composition, a date palm biochar in an amount of 0.05 to 3 wt. % based on a total weight of the cementitious material, a fine aggregate (FA) in an amount of 20 to 85 wt. % based on the total weight of the cement composition, a coarse aggregate (CA) in an amount of 0.01 to 60 wt. % based on the total weight of the cement composition and a plasticizer in an amount of 0.001 to 2 wt. % based on the total weight of the cement composition. Furthermore, the date palm biochar has a particle size in a range of 0.1 to 20 micrometers (μm). Additionally, the date palm biochar is at least one of a date palm leaves biochar (BioCl), and a date palm seeds biochar (BioCs).

In some embodiments, the date palm biochar is in the form of BioCl particles, and the BioCl particles are in the form of flake particles and circular particles having a rough surface morphology.

In some embodiments, the BioCl particles have an average particle size of 1 to 12 μm.

In some embodiments, the BioCl particles have an ash content of 20 to 30 wt. % as determined by ASTM D1506.

In some embodiments, the date palm biochar is in the form of BioCs particles and the BioCs particles are plate-like particles having a smooth surface morphology.

In some embodiments, the BioCs particles have an average particle size of 1 to 15 μm. In yet another embodiment, the BioCs particles have an ash content of 15 to 25 wt. % as determined by ASTM D1506.

In some embodiments, the cementitious material includes at least one selected from the group comprising of portland cement, pozzolan cement, gypsum cement, aluminous cement, silica cement, and alkaline cement.

In some embodiments, the cementitious material is type I ordinary portland cement (OPC), and the OPC has a standard specification of ASTM C150.

In some embodiments, the fine aggregate has a specific gravity of 2.2 to 2.8, and a standard specification of ASTM C128.

In some embodiments, the coarse aggregate has a specific gravity of 2.2 to 2.8, and a maximum particle size of at most 20 mm.

In some embodiments, the plasticizer of the present disclosure includes at least one selected from the group consisting of a lignosulfonate plasticizer, a polycarboxylate ether plasticizer, a melamine plasticizer, and a naphthalene plasticizer.

According to one aspect of the present disclosure, a method of producing a cured specimen is provided. The method includes mixing the cement composition with water to form a mortar composition, followed by casting the mortar composition in a mold to form a molded composition and curing the molded composition for 0.5-120 days, and forming the cured specimen.

In some embodiments, the water is at least one selected from the group consisting of tap water, groundwater, distilled water, deionized water, freshwater, and desalted water.

In some embodiments, the mortar composition has a flowability of 170 to 230 millimeters (mm) as determined by ASTM C1437/C230.

In some embodiments, the cured specimen has a compressive strength of 50 to 80 MPa as determined by ASTM C109/C109M.

In some embodiments, the cured specimen has a volume of permeable voids (VPV) of 6 to 12% by volume as determined by ASTM C642-13.

In some embodiments, the cured specimen has an ultrasonic pulse velocity (UPV) of 3 to 6 kilometers per second (km/s) as determined by ASTM C 597.

In some embodiments, the cured specimen has a thermal conductivity of 0.3 to 1 watt per meter-kelvin (W/mK) as determined by ASTM D7984 and ISO 22,007-2.

Aspects of the present disclosure also relate to a method for sequestering carbon by incorporating date palm biochar in a cement composition. The method includes heating a date palm material to a temperature of 500 to 700° C. at a heating rate of 5 to 20 degrees Celsius per minute (° C./min) to form the date palm biochar. In some embodiments, the date palm biochar has an average particle size in a range of 0.5 to 20 μm. In some embodiments, the date palm material is at least one of date palm leaves and date palm seeds. The method further includes mixing the date palm biochar, a cementitious material, a fine aggregate, a coarse aggregate, and a plasticizer to form the cement composition. In some embodiments, the resultant cement composition is curable.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart describing a method of producing a cured specimen, according to an aspect of the present disclosure;

FIG. 1B is a flowchart describing a method for sequestering carbon by incorporating date palm biochar in a cement composition, according to an aspect of the present disclosure;

FIG. 2 is a flow diagram depicting the stepwise processing of date palm leaves and date palm seeds, according to an aspect of the present disclosure;

FIG. 3A shows flowability of a mortar specimen using a flow table, according to an aspect of the present disclosure;

FIG. 3B shows the flow table caliper measuring the flowability of the mortar specimen, according to an aspect of the present disclosure;

FIG. 4A shows a scanning electron microscope (SEM) image for date palm leave biochar (BioCl) raw specimen, according to an aspect of the present disclosure;

FIG. 4B shows an SEM image for date palm seeds biochar (BioCs) raw specimen, according to an aspect of the present disclosure;

FIG. 5A shows results of compressive strength for BioCl mortar specimen, according to an aspect of the present disclosure;

FIG. 5B shows results of compressive strength for BioCs mortar specimen, according to an aspect of the present disclosure;

FIG. 6 illustrates a volume of permeable voids (VPV) of mortar mixes, according to an aspect of the present disclosure;

FIG. 7 shows ultrasonic pulse velocity (UPV) testing results for a control mortar specimen along with BioCl and BioCs, according to an aspect of the present disclosure;

FIG. 8 is shows compressive strength vs. ultrasonic pulse velocity for the control mortar specimen along with BioCl and BioCs, according to an aspect of the present disclosure;

FIG. 9A to FIG. 9D show experimental results of non-destructive testing (NDT) under control condition before application of an external load, according to an aspect of the present disclosure;

FIG. 10A to FIG. 10D illustrate the UPVs as a function of time for each BioCl and BioCs mortar specimen, according to an aspect of the present disclosure;

FIG. 11 shows thermal conductivity of BioCl reinforced blocks, according to an aspect of the present disclosure; and

FIG. 12 shows thermal conductivity of BioCs reinforced blocks, according to an aspect of the present disclosure.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

The terms “compound” and “derivative” as used herein, are used interchangeably, and refers to a chemical entity, whether in the solid, liquid, or gaseous phase, and whether in a crude mixture or purified and isolated.

The use of the terms “include,” “includes”, “including,” “have,” “has,” or “having” should be generally understood as open-ended and non-limiting unless specifically stated otherwise.

The terms “elements” and “components” include a single unit as well as more than a single unit unless specified otherwise.

As used herein, the term “cement” refers to a composition or substance with one or more constituents that is capable of binding materials together. The term includes reference to a dry, curable composition unless the context clearly dictates otherwise.

The phrase “cementitious material”, “cementitious binder material” or “binder” refers to materials or mixtures of materials that are “cements” or materials that are capable of forming cement or capable of forming materials with cement-like binding properties.

The terms “plasticizer” and “super-plasticizer” include a compound that is inert towards the binder, and such as serves as a medium such that the binder may be suspended or otherwise dispersed. The “plasticizer” or “super-plasticizer” is usually non-volatile at standard room temperature and pressure.

The present disclosure relates to a cement composition and a method of making thereof. The cement composition includes a cementitious material in an amount of 10 to 40 wt. % based on the total weight of the cement composition. In some further embodiments, the cement composition includes a cementitious material in an amount of 15 to 35 wt. %, preferably 20 to 30 wt. %, or even more preferably about 25 wt. %, based on the total weight of the cement composition. In an embodiment, the cementitious material is at least one selected from the group consisting of Portland cement, pozzolan cement, gypsum cement, aluminous cement, silica cement, and alkaline cement. In some embodiments, the cementitious material is Portland cement selected from the group consisting of type I, type II, type III, type, IV, type V, type Ia, IIa, IIIa, or a combination of any two or more types of Portland cement. In a specific embodiment, the cementitious material is the type I ordinary Portland cement (OPC), and the OPC has a standard specification of ASTM C150 [Standard Specification for Portland Cement, ASTM C150, which is incorporated herein by reference in its entirety].

As used herein, the term “portland cement” refers to the most common type of cement in general use developed from types of hydraulic lime and usually originating from limestone. It is a fine powder produced by heating materials in a kiln to form what is called clinker, grinding the clinker, and adding small amounts of other materials. The Portland cement is made by heating limestone (calcium carbonate) with other materials (such as clay) to >1400° C. This process in a kiln is also known as calcination, whereby a molecule of carbon dioxide is liberated from the calcium carbonate to form calcium oxide, or quicklime, which is then blended with the other materials that have been included in the mix to from calcium silicates and other cementitious compounds. The resulting hard substance, called “clinker” is then ground with a small amount of gypsum into a powder to make ordinary Portland cement (OPC). Several types of Portland cement are available with the most common being called ordinary Portland cement (OPC) which is grey in color.

The cement composition further includes date palm biochar in an amount of 0.05 to 3 wt. % based on the total weight of the cementitious material, preferably 0.1 to 2.5 wt. %, preferably 0.5 to 2 wt. %, or even more preferably 1 to 1.5 wt. % based on the total weight of the cementitious material. In some embodiments, the cement composition includes the date palm biochar with a particle size in a range of 0.1 to 20 micrometers (μm), preferably 1 to 18 μm, preferably 3 to 16 μm, preferably 5 to 14 μm, preferably 7 to 12 μm, or even more preferably 9 to 10 μm. Other ranges are also possible. In some embodiments, the date palm biochar is at least one of a date palm leaves biochar (BioCl), and a date palm seeds biochar (BioCs). Optionally, the date palm biochar can be produced from other plant parts of date palm, such as flowers, roots, or fruits. The date palm leaves are obtained from the leaves of the date palm tree of Saudi Arabia. In some embodiments, the date palm seeds are obtained from the seeds of the date palm tree of Saudi Arabia. In some embodiments, the date palm biochar is in the form of BioCl particles and the BioCl particles are in the form of flake particles and circular particles having a rough surface morphology.

As used herein, the term “rough surface” or “rough surface morphology” generally refers to the physical characteristics or features of a surface that deviate from smoothness or regularity. The term “rough surface morphology” may include unevenness, irregularities, and variations in height, shape, or texture of a surface at a micro or macro scale. In the present disclosure, the rough surface morphology of the BioCl particles includes, but is not limited to, bumps, ridges, valleys, peaks, or irregular shapes that may be randomly distributed or organized in a specific pattern. Additionally, the surface roughness may be determined by roughness average (Ra), root mean square (RMS) roughness, or peak-to-valley height. Roughness average (Ra) is calculated by averaging the surface roughness of at least 5, and preferably at least 10, representative locations spaced approximately evenly across the portion of the article carrying the BioCl particles. In some embodiments, it is preferred to measure the thickness at representative points across the longest dimension of the portion of the article that is covered with the BioCl particles. The standard deviation of roughness is found by calculating the standard deviation of the local average roughness across at least 5, and preferably at least 10, representative locations spaced approximately evenly across the portion of the article carrying the BioCl particles.

In some embodiments, the BioCl particles have an average particle size of 1 to 12 μm, preferably 2 to 10 μm, preferably 3 to 8 μm, or even more preferably 5 to 6 μm. In an embodiment, the BioCl particles have an ash content of 20 to 30 wt. % as determined by ASTM D1506 [Standard Test Methods for Carbon Black-Ash Content, ASTM D1506, which is incorporated herein by reference in its entirety]. In some embodiments, the BioCl particles have an average particle size of 1 μm, preferably 2 to 4 μm, preferably 5 μm, preferably 10 μm, or even more preferably about 11 to 12 μm. In an embodiment, the BioCl particles have an ash content of preferably between 20 to preferably 25, preferably between 25 to 30 wt. % as determined by ASTM D1506. In a preferred embodiment, the date palm biochar is in the form of BioCs particles, and the BioCs particles are plate-like particles having a smooth surface morphology. In some embodiment, the BioCs particles have an average particle size of 1 to 15 μm. In a preferred embodiment, the BioCs particles have an average particle size of preferably 2 μm, preferably 3 μm, preferably 4 μm, preferably 5 μm, preferably 6 μm, preferably 7 μm, preferably 8 μm, preferably 9 μm, and or even more preferably 10 μm. In another embodiment, the BioCs particles have an ash content of 15 to 25 wt. % as determined by ASTM D1506. In a preferred embodiment, the BioCs particles have an ash content of preferably 20, preferably 21, preferably 22, preferably 23, preferably 24, and preferably 25 wt. %. In some embodiments, a layer of BioCs particles may have a roughness average (Ra) of 0.1 to 20 μm, preferably 0.5 to 15 μm, preferably 1 to 10 μm, or even more preferably 3 to 5 μm. Other ranges are also possible.

As used herein, “aggregate” refers to a broad category of particulate material used in construction. Aggregates are a component of composite materials such as concrete; the aggregates serve as reinforcement to add strength to the overall composite material. Aggregates, from different sources, or produced by different methods, may differ considerably in particle shape, size and texture. Shape of the aggregates of the present disclosure may be cubical and reasonably regular, essentially rounded, angular, or irregular. Surface texture may range from relatively smooth with small exposed pores to irregular with small to large exposed pores. Particle shape and surface texture of both fine and coarse aggregates may influence proportioning of mixtures in such factors as workability, pumpability, fine-to-coarse aggregate ratio, and water requirement.

The cement further includes a fine aggregate (FA) in an amount of 20 to 85 wt. % based on the total weight of the cement composition, preferably 30 to 80 wt. %, preferably 40 to 70 wt. %, or even more preferably 50 to 60 wt. % based on the total weight of the cement composition. In some embodiments, the FA has a specific gravity of 2.2 to 2.8, preferably 2.3 to 2.7, preferably 2.4 to 2.6, or even more preferably about 2.5, and a standard specification of ASTM C128 [Standard Test Method for Relative Density (Specific Gravity) and Absorption of Fine Aggregate, ASTM C128, which is incorporated herein by reference in its entirety]. In a specific embodiment, the fine aggregate has a specific gravity of preferably 2.2, preferably 2.3, preferably 2.4, and preferably 2.5. In some more preferred embodiments, the fine aggregate contains about 80 to 95 wt. % SiO₂, preferably 85 to 90 wt. % SiO₂, or even more preferably about 88 wt. % SiO₂, each wt. % based on a total weight of the fine aggregate. In some further preferred embodiments, the fine aggregate contains about 5 to 20 wt. % sulfur, preferably 10 to 15 wt. % sulfur, or even more preferably about 12 wt. % sulfur, each wt. % based on a total weight of the fine aggregate. Other ranges are also possible.

In a preferred embodiment, the fine aggregate is sand, more preferably dune sand. As used herein, “sand” refers to a naturally occurring granular material composed of finely divided rock and mineral particles. It is defined by size in being finer than gravel and coarser than silt. The composition of sand varies, depending on the local rock sources and conditions, but the most common constituent of sand is silica (silicon dioxide, or SiO₂), usually in the form of quartz. In terms of particle size, sand particles range in diameter from 0.0625 mm to 2 mm. An individual particle in this range is termed a sand grain. By definition sand grains are between gravel (particles ranging from 2 mm to 64 mm) and silt (particles ranging from 0.004 mm to 0.0625 mm). In a most preferred embodiment, the fine aggregate of the cement composition is dune sand with a specific gravity of 2.2-3.2, preferably 2.4-3.0, more preferably 2.5-2.7, or about 2.6.

In some embodiments, the fine aggregate is dune sand having a specific gravity of about 2.51 and an absorption capacity of 0.1 to 1 wt. % based on an initial weight of the dune sand, preferably 0.2 to 0.8 wt. %, or even more preferably about 0.4 to 0.6 wt. % based on the initial weight of the dune sand. The dune sand contains about 88 wt. % SiO₂, and about 12 wt. % sulfur, each wt. % based on the total weight of the fine aggregate. Other ranges are also possible. As used herein, the term “water absorption” or “absorption capacity”, generally refers to the ratio of the weight of water absorbed to the weight of the dry material. As used herein, the term “dry density” refers to the ratio of total dry mass of aggregate to the total volume of aggregate.

The cement composition further includes a coarse aggregate (CA) in an amount of 0.01 to 60 wt. % based on the total weight of the cement composition, preferably 5 to 55 wt. %, preferably 10 to 45 wt. %, preferably 20 to 40 wt. %, or even more preferably about 30 wt. % based on the total weight of the cement composition. In some embodiments, the coarse aggregate has a specific gravity of 2.2 to 2.8, preferably 2.3 to 2.7, preferably 2.4 to 2.6, or even more preferably about 2.5. In some further embodiments, the coarse aggregate has a maximum particle size of at most 20 mm, preferably at most 18 mm, preferably at most 16 mm, or even more preferably at most 14 mm. Other ranges are also possible.

In a preferred embodiment, the course aggregate present in the cement composition is crushed limestone. As used herein, limestone refers to a sedimentary rock composed largely of the minerals calcite and aragonite, which are different crystal forms of calcium carbonate (CaCO₃). Limestone is naturally occurring and can be found in skeletal fragments of marine organisms such as coral, forams, and molluscs. Crushed limestone is generated during the crushing and grinding of limestone rocks. The crushed limestone used herein may have an average particle size greater than 1 mm. In one embodiment, the crushed limestone has an average particle size of 1.5-32 mm, preferably 2-30 mm, preferably 4-28 mm, preferably 6-24 mm, preferably 8-20 mm, preferably 10-18 mm, preferably 12-16 mm. The crushed limestone may contain materials including, but not limited to, calcium carbonate, silicon dioxide, quartz, feldspar, clay minerals, pyrite, siderite, chert and other minerals. In a most preferred embodiment, the coarse aggregate of the cement composition is crushed limestone with a specific gravity of 2.1-3.0, preferably 2.2-2.8, more preferably 2.4-2.7, or about 2.56.

In some preferred embodiments, the coarse aggregate is limestone having a specific gravity of about 2.56, and an absorption of 0.5 to 2 wt. %, preferably 1 to 1.5 wt. %, or even more preferably about 1.25 wt. % based on an initial weight of the limestone. In some more preferred embodiments, the limestone has a maximum particle size of at most about 18.7 mm.

The cement composition further includes a plasticizer in an amount of 0.001 to 2 wt. % based on the total weight of the cement composition. The plasticizer includes at least one included from the group consisting of a lignosulfonate plasticizer, a polycarboxylate ether plasticizer, a melamine plasticizer, and a naphthalene plasticizer. In some embodiments, the plasticizer is a combination of two or more plasticizers selected from the above group. In some specific embodiments, the plasticizer is a combination of one or more plasticizers included from the above group with an organic non-volatile compound.

As used herein, a “plasticizer” is an additive that increases the plasticity or fluidity of slurry. Plasticizers increase the workability of “fresh” cement composition, allowing it to be placed more easily, with less consolidating effort. A superplasticizer is a plasticizer with fewer deleterious effects. A “superplasticizer” refers a chemical admixture used herein to provide a well-dispersed particle suspension in the wet cement composition. The superplasticizer may be used to prevent particle segregation and to improve the flow characteristics of the wet cement composition. The superplasticizer may be a polycarboxylate, e.g. a polycarboxylate derivative with polyethylene oxide side chains, a polycarboxylate ether (PCE) superplasticizer, such as the commercially available Glenium 51®. Polycarboxylate ether superplasticizers may allow a significant water reduction at a relatively low dosage, thereby providing good particle dispersion in the wet concrete slurry. Polycarboxylate ether superplasticizers are composed of a methoxy-polyethylene glycol copolymer (side chain) grafted with methacrylic acid copolymer (main chain). Exemplary superplasticizers that may be used in addition to, or in lieu of a polycarboxylate ether superplasticizer include, but are not limited to, alkyl citrates, sulfonated naphthalene, sulfonated alkene, sulfonated melamine, lignosulfonates, calcium lignosulfonate, naphthalene lignosulfonate, polynaphthalenesulfonates, formaldehyde, sulfonated naphthalene formaldehyde condensate, acetone formaldehyde condensate, polymelaminesulfonates, sulfonated melamine formaldehyde condensate, polycarbonate, other polycarboxylates, other polycarboxylate derivatives comprising polyethylene oxide side chains, and the like and mixtures thereof. In a preferred embodiment, the cement composition has a weight percentage of the plasticizer ranging from 0.1-3.0% relative to the total weight of the composition, preferably 0.2-2.5%, preferably 0.5-2.0%, preferably 1.0-1.8%, preferably 1.2-1.6%, or about 1.5% relative to the total weight of the cement composition. Other ranges are also possible.

In an embodiment, the cement composition may further include a surfactant. In a preferred embodiment, the surfactant may be a nonionic surfactant, an anionic surfactant, a cationic surfactant, a viscoelastic surfactant, or a zwitterionic surfactant. The surfactants may include, but are not limited to, ammonium lauryl sulfate, sodium lauryl sulfate (SLS), sodium dodecyl sulfate (SDS), alkyl-ether sulfates sodium laureth sulfate (sodium lauryl ether sulfate (SLES), sodium myreth sulfate, docusate (dioctyl sodium sulfosuccinate), perfluorooctanesulfonate (PFOS), perfluorobutanesulfonate, alkyl-aryl ether phosphates, alkyl ether phosphates, octenidine dihydrochloride; cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), CHAPS (3-[(3-cholamidopropyl) dimethylammonio]-1-propanesulfonate), cocamidopropyl hydroxysultaine, ocamidopropyl betaine, phospholipids, and sphingomyelins. In a preferred embodiment, the cement composition has a weight percentage of the surfactant ranging from 0.1-3.0% relative to the total weight of the composition, preferably 0.2-2.5%, preferably 0.5-2.0%, preferably 1.0-1.8%, preferably 1.2-1.6%, or about 1.5% relative to the total weight of the cement composition. Other ranges are also possible.

The surfactant may include primary and secondary emulsifiers. Hereinafter, the primary and secondary emulsifiers are collectively referred to as the “emulsifiers” or “surfactants” and individually referred to as the “emulsifier” or “surfactant,” unless otherwise specified. The primary emulsifier is a polyaminated fatty acid. The primary emulsifier includes a lower hydrophilic-lyophilic balance (HLB) in comparison to the secondary emulsifier. The primary emulsifier may include, but are not limited to, span 60, span 85, span 65, span 40, and span 20. The primary emulsifier is sorbitan oleate, also referred to as the span 80. The secondary emulsifier may include, but are not limited to triton X-100, Tween™ 80, Tween™ 20, Tween™ 40, Tween™ 60, Tween™ 85, OP4 and OP 7. The secondary emulsifier includes a biosurfactant such as a rhamnolipid surfactant. In an embodiment, the surfactant may be neopelex or stearic acid.

The cement composition may further include a defoaming agent. As used herein, the term “deforming agent” refers to the chemical additive that reduces and hinders foam formation in industrial process liquids. The deforming agent may include, but are not limited to, 2-octanol, oleic acid, paraffinic waxes, amide waxes, sulfonated oils, organic phosphates, silicone oils, mineral oils, and dimethylpolysiloxane. The defoaming agent may be dimethyl silicone polymer or polyoxy propylene glycerin ether. In a preferred embodiment, the cement composition has a weight percentage of the defoaming agent ranging from 0.01-1.0% relative to the total weight of the composition, preferably 0.02-0.8%, preferably 0.03-0.6%, preferably 0.04-0.4%, preferably 0.05-0.2%, or about 0.1% relative to the total weight of the cement composition.

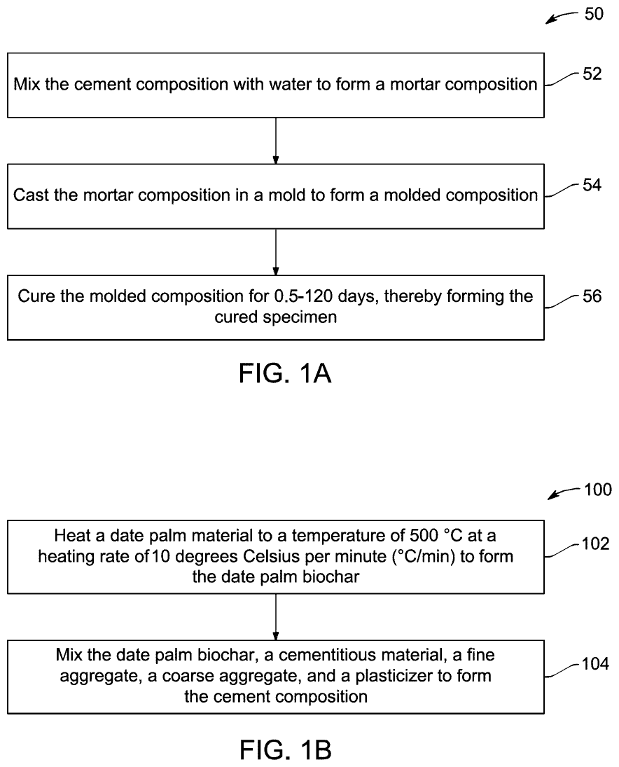

FIG. 1A illustrates a flow chart of a method 50 of producing a cured specimen. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 mixing the cement composition with water to form a mortar composition. The cement composition includes a cementitious material in an amount of 10 to 40 wt. % based on a total weight of the cement composition; a fine aggregate (FA) in an amount of 20 to 85 wt. % based on the total weight of the cement composition; a coarse aggregate (CA) in an amount of 0.01 to 60 wt. % based on the total weight of the cement composition; a plasticizer in an amount of 0.001 to 2 wt. % based on the total weight of the cement composition; and a date palm biochar in an amount of 0.05 to 3 wt. % based on a total weight of the cementitious material. The date palm biochar has a particle size in a range of 0.1 to 20 micrometers (μm). The date palm biochar is at least one of a date palm leaves biochar (BioCl), and a date palm seeds biochar (BioCs). The water at least one selected from the group consisting of tap water, ground water, distilled water, deionized water, freshwater, and de-salted water. In some embodiments, a weight ratio of the water to the cementitious material is in a range of 0.2:1 to 1:1, more preferably, 0.3:1 to 0.8:1, or even more preferably about 0.5:1 to 0.6:1. In some further embodiments, a weight ratio of the FA to the cementitious material is in a range of 5:1 to 1:1, preferably 4:1 to 2:1, or even more preferably about 2.75:1. Other ranges are also possible. The mortar composition having a flowability of 170 to 230 millimeters (mm), preferably 175, preferably 180, preferably 185, preferably 190, preferably 195, preferably 200, preferably 205, preferably 210, preferably 215, preferably 220, and preferably 225 mm. as determined by ASTM C1437/C230 [Standard Test Method for Flow of Hydraulic Cement Mortar, ASTM C1437, which is incorporated herein by reference in its entirety].

At step 54, the method 50 include casting the mortar composition in a mold to form a molded composition. The casting may be performed by any of the conventional methods known in the art. In an embodiment, the casting may be substituted by an extrusion molding, a blow molding, an injection molding, and a rotational molding. In an embodiment, the mold is a briquette mold. The mold may be made up of a material selected from a group of any alloy or metal such as stainless steel, bronze, and nichrome. The mold may include, but are not limited to shapes such as spherical, cylindrical, cubical, cuboidal, pentagonal, hexagonal, and rhombic. In some embodiments, the mortar composition may be transferred to 300 mm×300 mm×50 mm cubic brass molds, specified by ASTM C192/C192M [Standard Practice for Making and Curing Concrete Test Specimens in the Laboratory, ASTM C192/C192M, which is incorporated herein by reference in its entirety].

At step 56, the method 50 includes curing the molded composition for 0.5-120 days, thereby forming the cured specimen. In some preferred embodiments, the molded composition is cured for preferably 5, preferably 10, preferably 15, preferably 20, preferably 25, preferably 30, preferably 35, preferably 40, preferably 45, preferably 50, preferably 55, preferably 60, preferably 65, preferably 70, preferably 75, preferably 80, preferably 85, or preferably for about 90 days. In some specific embodiments, the molded composition is cured for 28 days thereby forming the cured specimen. In some other embodiments, the molded composition is cured for 90 days.

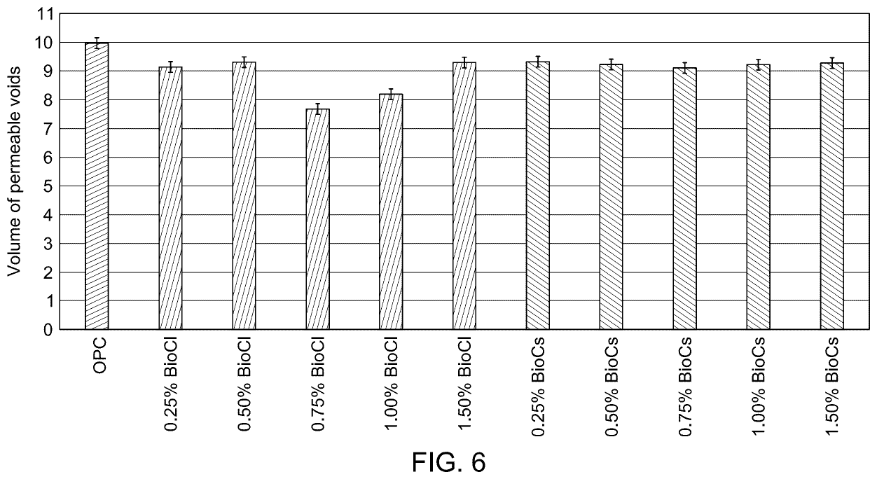

The cured specimen has a volume of permeable voids (VPV) of 6 to 12% by volume as determined by ASTM C642-13 [Standard Test Method for Density, Absorption, and Voids in Hardened Concrete, ASTM C642-13, which is incorporated herein by reference in its entirety]. Referring to FIG. 6, when the date palm biochar is BioCl, the cured specimen has a volume of permeable voids (VPV) of preferably 7, preferably 8, preferably 10, preferably 11% by volume. Also referring to FIG. 6, when the date palm biochar is BioCs, the cured specimen has a volume of permeable voids (VPV) of preferably 6, preferably 7, preferably 8, preferably 10, preferably 11 to about 12% by volume. In some embodiments, the volume of permeable voids (VPV) is preferably 8, preferably 9, and preferably 10% by volume. Other ranges are also possible.

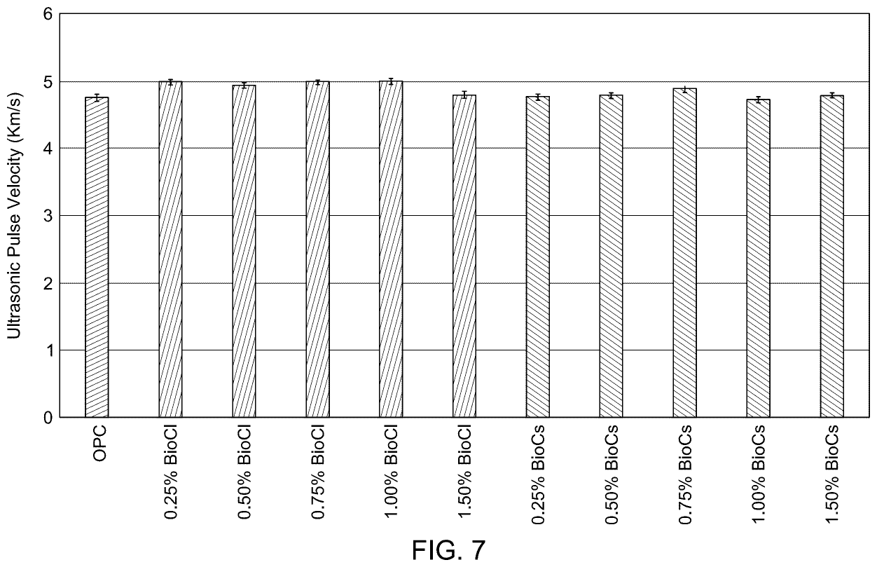

In some embodiments, the cured specimen has an ultrasonic pulse velocity (UPV) of 3 to 6 kilometers per second (km/s) as determined by ASTM C597 [Standard Test Method for Pulse Velocity Through Concrete, ASTM C597, which is incorporated herein by reference in its entirety]. Referring to FIG. 7, when the date palm biochar is BioCl, the cured specimen has an ultrasonic pulse velocity (UPV) of preferably 3, preferably 4, preferably 5 to about 6 kilometers per second (km/s). Also referring to FIG. 7, when the date palm biochar is BioCs, the cured specimen has an ultrasonic pulse velocity (UPV) of preferably 3, preferably 4, preferably 5 to about 6 kilometers per second (km/s). Other ranges are also possible.

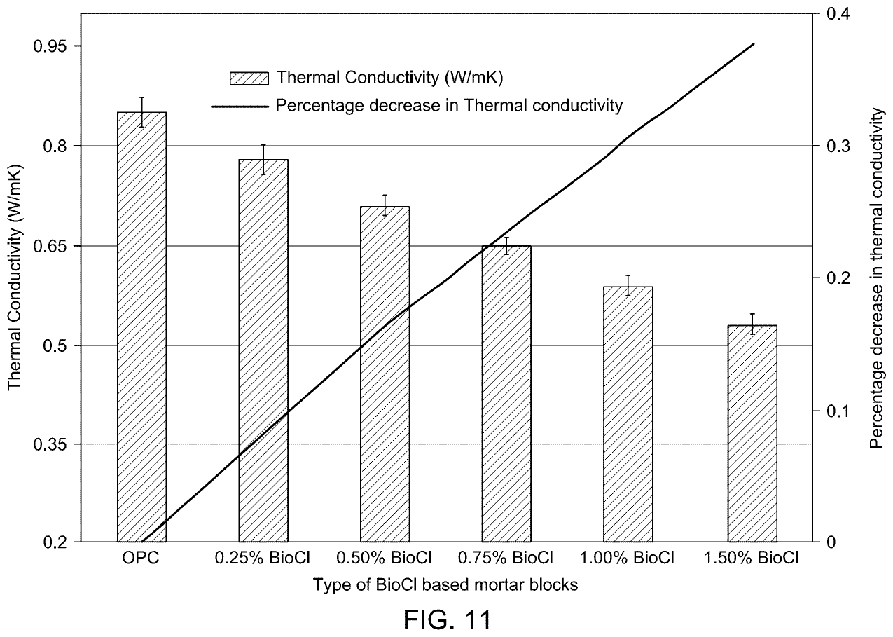

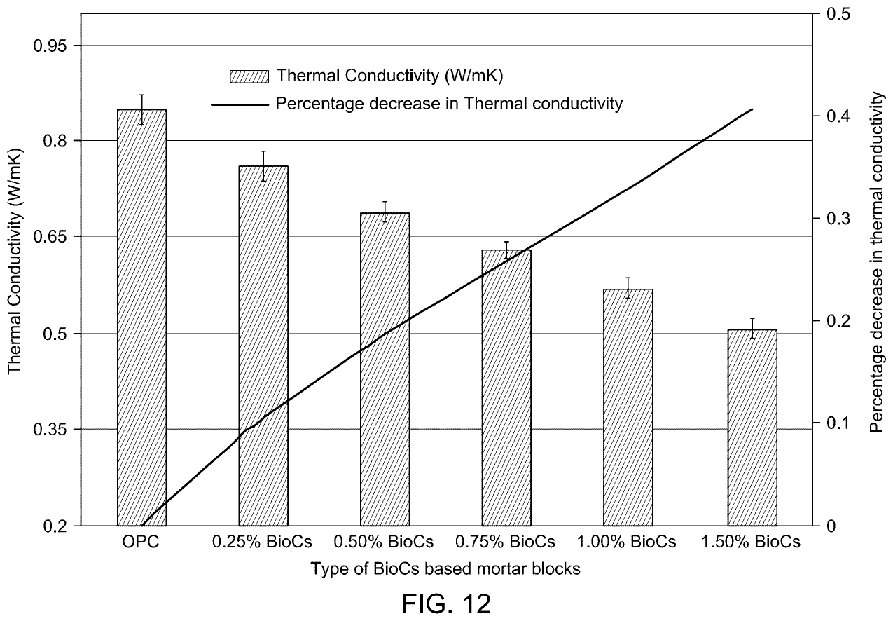

In some embodiments, the cured specimen has a thermal conductivity of 0.3 to 1 watts per meter-kelvin (W/mK) as determined by ASTM D7984 [Standard Test Method for Measurement of Thermal Effusivity of Fabrics Using a Modified Transient Plane Source (MTPS) Instrument, ASTM D7984, which is incorporated herein by reference in its entirety] and ISO 22,007-2 [Determination of thermal conductivity and thermal diffusivity, ISO 22,007-2, which is incorporated herein by reference in its entirety]. Referring to FIG. 11, when the date palm biochar is BioCl, the cured specimen has a thermal conductivity of preferably 0.3, preferably 0.4, preferably 0.5, preferably 0.6, preferably 0.7, preferably 0.8, preferably 0.9 to about 1 watt per meter-kelvin (W/mK). Referring to FIG. 12, when the date palm biochar is BioCs, the cured specimen has a thermal conductivity of preferably 0.3, preferably 0.4, preferably 0.5, preferably 0.6, preferably 0.7, preferably 0.8, preferably 0.9 to about 1 watt per meter-kelvin (W/mK). Other ranges are also possible.

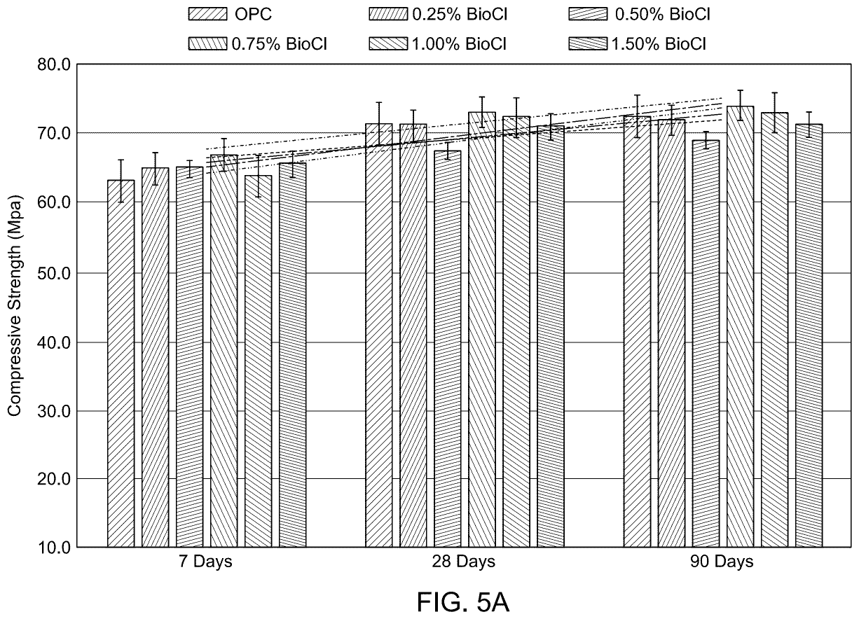

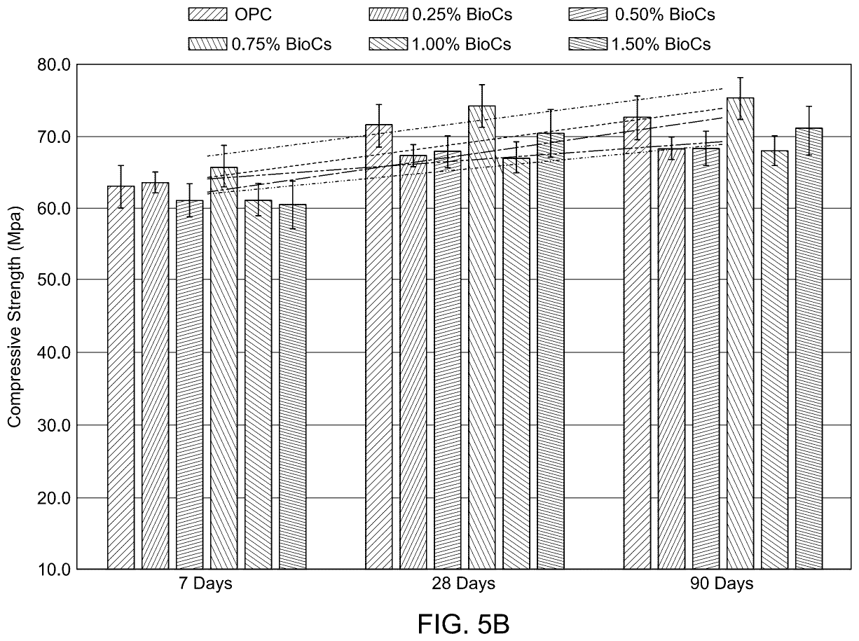

The cured specimen has a compressive strength of 50 to 80 MPa as determined by ASTM C109/C109M. In some embodiments, referring to FIG. 5A, when the date palm biochar is BioCl, the compressive strength of the cured specimen is preferably 55, preferably 60, preferably 65, preferably 70, to preferably about 75 MPa. In some further embodiments, referring to FIG. 5B, when the date palm biochar is BioCs, the compressive strength of the cured specimen is preferably 55, preferably 60, preferably 65, preferably 70, to preferably about 75 MPa. Other ranges are also possible.

FIG. 1B illustrates a flow chart of a method 100 for sequestering carbon by incorporating date palm biochar in a cement composition. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes heating a date palm material to a temperature of 500 to 700° C. at a heating rate of 5 to 20 degrees Celsius per minute (C/min) to form the date palm biochar. The date palm material of at least one of the date palm leaves and the date palm seeds. In some further embodiments, the date palm leaves and the date palm seeds may be obtained from date palm trees originated from Saudi Arabia. In a preferred embodiment, the heating is performed at a temperature of preferably 510, preferably 515, preferably 520, preferably 525, preferably 530, preferably 535, preferably 540, preferably 545, preferably 550, preferably 555, preferably 560, preferably 565, preferably 570, preferably 575, preferably 580, preferably 585, preferably 590, preferably 595, preferably 600, preferably 605, preferably 610, preferably 615, preferably 620, preferably 625, preferably 630, preferably 635, preferably 640, preferably 645, preferably 650, preferably 655, preferably 660, preferably 665, preferably 670, preferably 675, preferably 680, preferably 685, preferably 690, or preferably 695° C. In a specific embodiment, the process of heating is performed at a temperature of 500° C. for 30 minutes. In a specific embodiment, the process of heating is performed at a temperature of 500° C. for about 2 hours. In some embodiments, the heating rate to form the date palm biochar is preferably 5, preferably 6, preferably 7, preferably 8, preferably 9, preferably 10, preferably 11, preferably 12, preferably 13, preferably 14, preferably 15, preferably 16, preferably 17, preferably 18 to about 19 degrees Celsius per minute (° C./min). In some embodiments, heating may be performed by placing the date palm material into a furnace such as a tube furnace, for example, in a ceramic crucible (e.g., an alumina crucible) or other forms of containment, and heating to the temperatures described above. The furnace is preferably equipped with a temperature control system, which may provide a heating rate of up to 50° C./min, or preferably up to 40° C./min, or preferably up to 30° C./min, preferably up to 20° C./min. Other ranges are also possible.

The date palm biochar has an average particle size in a range of 0.5 to 20 μm. In some embodiments, the date palm biochar has an average particle size in a range of preferably 0.6, preferably 0.7, preferably 0.8, preferably 0.9, preferably 1 to 2, preferably 2 to 3, preferably 3 to 4, preferably 4 to 5, preferably 5 to 6, preferably 6 to 7, preferably 7 to 8, preferably 8 to 9, preferably 10 to 11, preferably 11 to 12, preferably 12 to 13, preferably 13 to 14, preferably 14 to 15, preferably 15 to 16, preferably 16 to 17, preferably 17 to 18, preferably 18 to 19, preferably to about 19 μm. Other ranges are also possible.

At step 104, the method 100 includes mixing the date palm biochar, a cementitious material, a fine aggregate, a coarse aggregate, and a plasticizer to form the cement composition. The cementitious material in an amount of 10 to 40 wt. % based on the total weight of the cement composition; the fine aggregate (FA) in an amount of 20 to 85 wt. % based on the total weight of the cement composition; the coarse aggregate (CA) in an amount of 0.01 to 60 wt. % based on the total weight of the cement composition, the plasticizer in an amount of 0.001 to 2 wt. % based on the total weight of the cement composition, and the date palm biochar in an amount of 0.05 to 3 wt. % based on the total weight of the cementitious material. The date palm biochar has a particle size in a range of 0.1 to 20 micrometers (μm); the date palm biochar is at least one of a date palm leaves biochar (BioCl), and a date palm seeds biochar (BioCs). The cement composition prepared by the method of the present disclosure is curable.

### EXAMPLES

The following examples demonstrate a cement composition as described herein. The examples are provided solely for illustration and are not to be construed as limitations of the present disclosure, as many variations thereof are possible without departing from the spirit and scope of the present disclosure.

### Example 1: Materials

Ordinary Portland cement (OPC) Type-I was utilized as the primary binding material, acquired from a Saudi Ready-mix factory, followed by ASTM C150. The cement's specific gravity was determined to be 3.16. Two biochar types were produced using date palm leaves and seeds collected from local farms in the Kingdom of Saudi Arabia. Dune sand was utilized as a fine aggregate (FA) in all mortar and concrete mixtures. FA has a specific gravity of 2.51 and an absorption capacity of 0.6%. The following properties were noted as per ASTM C 128 [ASTM C 128 (2003) Standard test method for density, relative density (specific gravity), and absorption of fine aggregate. 2003, 1-7, which is incorporated herein by reference in its entirety]. According to the study of the particle size distribution, FA particles successfully passed the ASTM sieve sizes #4, #8, #16, #30, #50, #100, and #200 with scores of 100%, 100%, 100%, 76%, 12%, 4%, and 3%, respectively. According to the chemical analysis, FA contained 88% SiO₂ and 12% sulfur. Crushed limestone was employed as a coarser aggregate (CA), having a bulk specific gravity of 2.56, absorption of 1.25%, and maximum particle size of 18.7 mm. All mortar and concrete mixtures were prepared with tap water as a mix of water.

### Example 2: Biochar Production

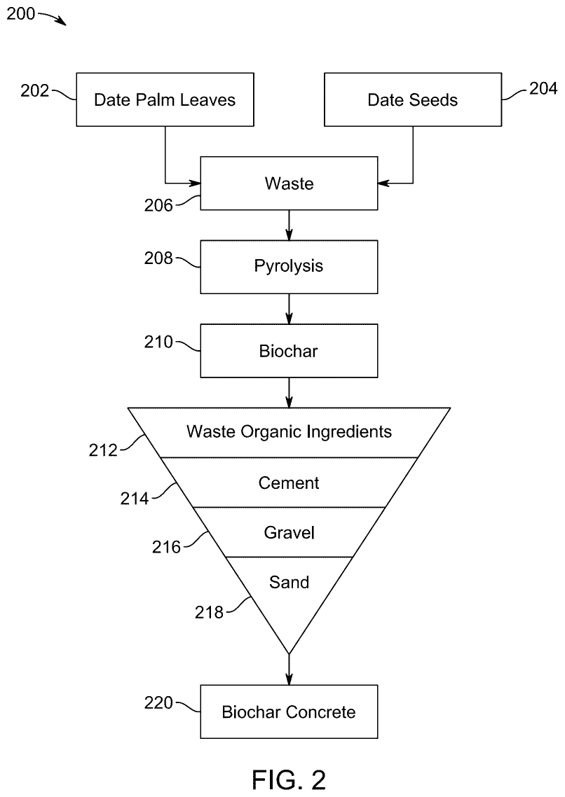

Biochar (BC) was produced using locally available date palm leaves (202) and seeds (204); each biochar was formed at 500° C. utilizing a slow pyrolysis process with a heating rate of 10° C./min for 2 h. FIG. 2 depicts the stepwise processing of the raw materials (200) along with the above-mentioned development process. In this step, the date palm leaves (202) or date palm seeds (204) were processed to obtain a waste (206). Tat step 208, the date palm material is heated to a temperature of 500 to 700° C. at a heating rate of 5 to 20 degrees Celsius per minute (C/min) to form the date palm biochar (210). The date palm biochar (210) was further mixed with other waste organic ingredients (212), cement (214), gravel (216), and sand (218) to form the cement composition. Each step was performed rigorously to eradicate any human error. Mix design and formulation of mortar and concrete samples. By altering the kind and dose of two distinct BCs and a BC-free mix as a control mix, eleven mortar mixes were created per ASTM C311 specifications and processed accordingly (FIG. 2). The ratio of water to cement is 0.5:1, and 1:2.75 of cement to fine aggregate (FA) were maintained. The BCs were incorporated as an additive at dosages of 0.25%, 0.50%, 0.75%, 1.00%, and 1.50% by wt. of OPC. Furthermore, the present disclosure includes investigations of various variations to understand the effect of increasing biochar content on the mechanical properties of concrete produced. Therefore, the mortar specimens were assigned as BioCl and BioCs, for date palm leaves and seeds were used as feedstock to prepare biochar. Table 1 below summarizes the mixture proportions for mortar specimens. Master Glenium 110 M were used as a superplasticizer to increase the flow of mortar. Twenty-two concrete masonry block specimens of 300×300×50 mm were made using ordinary Portland cement (OPC). Table 2 below summarizes the mixture proportions for concrete masonry blocks. The dry material, including biochar, was combined for 2 min in a rotary mixer. Next, water and a superplasticizer were added to the dry mix and rotated for 3-5 min to get the paste of uniform consistency. Destructive and nondestructive tests were conducted on the established samples to judge the mechanical performance of the biochar-based mortar. The mortar specimens were cast for mechanical testing, and concrete beams were cast for thermal analysis. All specimens were produced and cured according to ASTM C305-20 and ASTM C192/C192M. The proceeding section details the methodology adopted for testing the developed specimens.

### Example 3: Methods

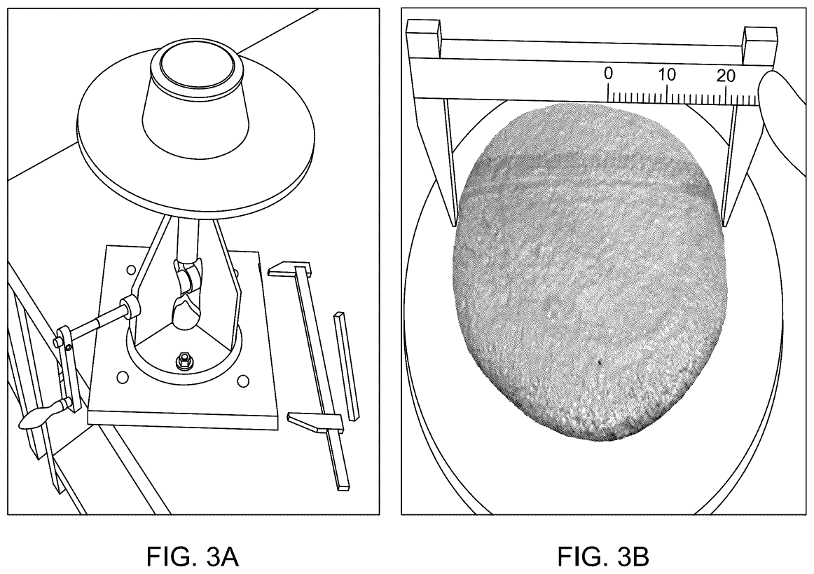

A protocol was established to ascertain the mechanical and thermal capabilities of the biochar-based mortar and concrete specimens. FIG. 3A and FIG. 3B illustrates the flowability of the mortar specimen. The effects of including BioCl and BioCs on the flowability properties were evaluated using flow testing. Fresh mortar's flow was measured using an ELE International brand flow table that weighs 25 kg and comes equipped with an accessory flow mold, caliper, and tamper by following ASTM C1437/C230. The flow table evaluated the flowability of fresh mortar, including measuring the flowability of mortar in four directions and noting down the average. Scanning electron microscopic imaging (SEM) was conducted to assess the surface morphology of the produced biochar.

TABLE 1
Mixture proportions of biochar-mortar specimen

| | | BC | | | | | |
|---|---|---|---|---|---|---|---|
| | | dosage | Cement | Sand | Water | SP | BC |
| BC | Mix | (%) | (kg/m³) | (kg/m³) | (kg/m³) | (%) | (kg/m³) |
| None | BC-Free | 0 | 667 | 1833 | 333 | 0.5 | 0.000 |
| BioCl | BioCl-0.25% | 0.25 | 667 | 1833 | 333 | 0.5 | 1.67 |
| | BioCl-0.50% | 0.50 | 667 | 1833 | 333 | 0.5 | 3.33 |
| | BioCl-0.75% | 0.75 | 667 | 1833 | 333 | 0.5 | 5.00 |
| | BioCl-1.00% | 1.00 | 667 | 1833 | 333 | 0.5 | 6.67 |
| | BioCl-1.50% | 1.50 | 667 | 1833 | 333 | 0.5 | 10.00 |
| BioCs | BioCs-0.25% | 0.25 | 667 | 1833 | 333 | 0.5 | 1.67 |
| | BioCs-0.50% | 0.50 | 667 | 1833 | 333 | 0.5 | 3.33 |
| | BioCs-0.75% | 0.75 | 667 | 1833 | 333 | 0.5 | 5.00 |
| | BioCs-1.00% | 1.00 | 667 | 1833 | 333 | 0.5 | 6.67 |
| | BioCs-1.50% | 1.50 | 667 | 1833 | 333 | 0.5 | 10.00 |

TABLE 2
Mixture proportions of biochar-concrete masonry specimen

| | | BC | | | | | | |
|---|---|---|---|---|---|---|---|---|
| BC | | dosage | Cement | Sand | Gravel | Water | SP | BC |
| type | Mix | (%) | (kg/m³) | (kg/m³) | (kg/m³) | (kg/m³) | (%) | (kg/m³) |
| None | BC-Free | 0 | 467 | 685 | 933 | 233.5 | 0.5 | 0.000 |
| BioCl | BioCl-0.25% | 0.25 | 467 | 685 | 933 | 233.5 | 0.5 | 1.168 |
| | BioCl-0.50% | 0.50 | 467 | 685 | 933 | 233.5 | 0.5 | 2.335 |
| | BioCl-0.75% | 0.75 | 467 | 685 | 933 | 233.5 | 0.5 | 3.503 |
| | BioCl-1.00% | 1.00 | 467 | 685 | 933 | 233.5 | 0.5 | 4.670 |
| | BioCl-1.50% | 1.50 | 467 | 685 | 933 | 233.5 | 0.5 | 7.005 |
| BioCs | BioCs-0.25% | 0.25 | 467 | 685 | 933 | 233.5 | 0.5 | 1.168 |
| | BioCs-0.50% | 0.50 | 467 | 685 | 933 | 233.5 | 0.5 | 2.335 |
| | BioCs-0.75% | 0.75 | 467 | 685 | 933 | 233.5 | 0.5 | 3.503 |
| | BioCs-1.00% | 1.00 | 467 | 685 | 933 | 233.5 | 0.5 | 4.670 |
| | BioCs-1.50% | 1.50 | 467 | 685 | 933 | 233.5 | 0.5 | 7.005 |

Compressive strength was calculated using a compression testing machine on a 50 mm3 mortar specimen. The following test was conducted according to ASTM C 109. Three samples were tested for every mix design after curing for 7, 28, and 90 days on an ELE ADR-Auto V 2.0 compression testing machine at a constant loading rate of 0.9 kN/s. The mean of three different readings was recorded as compressive strength; keeping in mind that the standard deviation was within allowable limits. Water absorption and voids in hardened mortar were also determined by using 50 mm mortar cubes, as per ASTM C642-13. PUNDIT portable ultrasonic tester was utilized to determine the ultrasonic pulse velocity (UPV) into different mortar specimens for nondestructive testing (NDT) as per ASTM C 597. A low thermal conductivity concrete block reduces heat dissipation into and out of the building structure, maximizes material capacity and operating costs, and reduces energy consumption. Therefore, a thermal conductivity test was performed to verify the thermal characteristic of the masonry concrete blocks as per ASTM D7984 and ISO 22,007-2 guidelines.

### Example 4: Characterization of Biochar

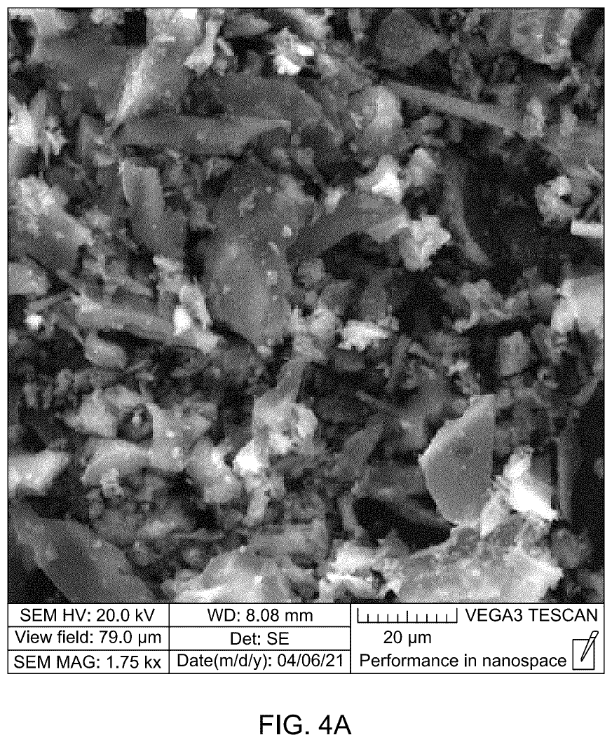

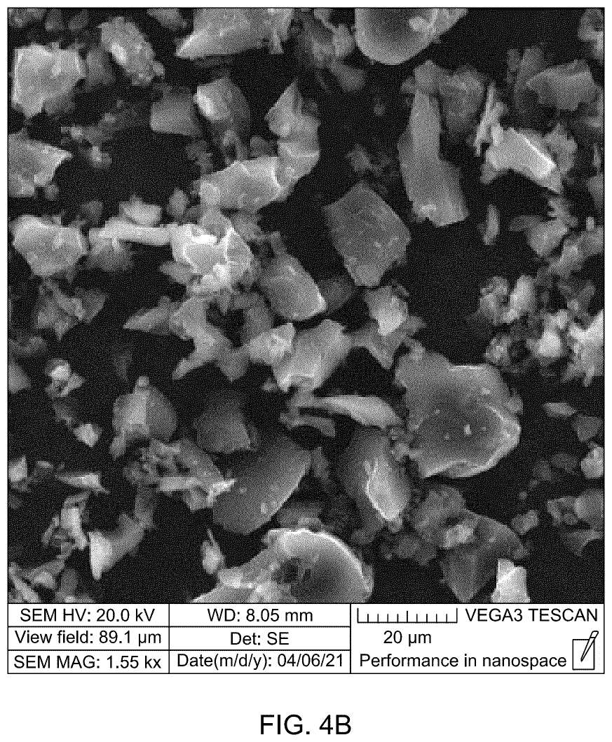

The ash content of produced biochar was estimated using ASTM D1506 and found to be 25.13% and 20.82% for BioCl and BioCs, respectively. The results showed that the higher ash content of BioCl than BioCs expected to exhibit higher pozzolanic activity and contribute significantly to strengthening the biochar-mortar composite. Referring to FIGS. 4A and 4B illustrate the SEM images for BioCl and BioCs raw specimens are presented, respectively. The images depict a discrete porous pattern with large particulates surrounded by smaller dense particles. In particular, the surface structure of BioCl exhibits rough morphology with sharp flakes surrounded by tiny circular particles with particle sizes of 2-8 μm. However, the surface of BioCs showed smooth plate-like particles of varied sizes from 2 to 10 μm. Since biochar is a carbon-rich material; it presents an added benefit for concrete materials with the ability to absorb the heat from the surrounding. This benefits concrete application in the real world since the biochar material can absorb the extra heat generated by cement's chemical reaction. From the presented results, adding biochar material to concrete will fill the pores and void in the concrete, resulting in increased density and better compressive strength.

### Example 5: Influence of Biochar on the Flowability of Mortar

Table 3 represents the flowability test results for BioCl and BioCs specimens. The presented results in Table 3 show that both BioCl and BioCs specimens depicted similar flowability characteristics. Furthermore, it was found that an increase in biochar content (0.25-1.5%) for both BioCl and BioCs mortar specimens increased the flowability of the samples (Table 1). In addition, it was observed that the flowability started to reduce beyond 1.00% content of BioCl. This is associated with the rougher surface morphology of BioCl, as confirmed by SEM analysis as shown in FIG. 4A. A similar trend was observed for BioCs samples, with peak flowability recorded at 1.50%. In this context, it can be deduced that 1.00% and 1.50% can be considered an optimum dosage of BioCl and BioCs materials from the flowability and workability of fresh mortar.

TABLE 3
Flow testing results for biochar-based mortar

| | Biochar | Flow |
|---|---|---|
| Mix type | proportion | (mm) |
| BioCl | 0.25% | 185 |
| | 0.50% | 195 |
| | 0.75% | 195 |
| | 1.00% | 210 |
| | 1.50% | 195 |
| BioCs | 0.25% | 185 |
| | 0.50% | 187 |
| | 0.75% | 185 |
| | 1.00% | 185 |
| | 1.50% | 205 |

### Example 6: Influence of Biochar on Compressive Strength of Mortar

FIG. 5A and FIG. 5B depict the results of compressive strength, respectively, for BioCl and BioCs mortar mix with curing periods of 7, 28, and 90 days. The addition of biochar gradually increased the compressive strength of the specimens compared to the control mortar. The phenomenon is due to the increased density and pozzolanic action [Constr Build Mater, 2020, 234:117338 & Cem Concr Compos, 2021, 119:104022, which is incorporated herein by reference in its entirety]. The highest early compressive strength at 7 days was recorded for the mortar specimen with 0.75% BioCl. However, specimens with 1% and 1.5% BioCl depicted lower compressive strength. At 28 days and 90 days, 0.75% BioCl depicted the highest compressive strength compared to the control mortar. Thus, the observation is that the compressive strength of the mortar specimens increased after adding biochar until 0.75% dosage; after that, a decrease in the compressive strength was noticed. This phenomenon can be attributed to the nano-voids starting to fill up with the biochar material completely, these nanoparticles tend to gather on the periphery of the fine aggregate. Since the biochar material is weak, these extra-concentrated particles provide an easy route for the crack to propagate, thus reducing the biochar-mortar specimen's compressive strength. The results showed the peak compressive strength of about 73 MPa for 0.75% BioCl, which was 0.5%, 2.15%, 7%, 0.5%, and 2.5% higher than those accomplished by control, 0.25% BioCl, 0.5% BioCl, 0.75% BioCl, 1% BioCl, and 1.5% BioCl mixtures, respectively. The more significant improvement in compressive strength of 0.75% BioCl mix is attributed to the formation of a denser microstructure. Therefore, adding 0.75% of BioCl resulted in a mortar surface with limited pores and voids, slightly improving compressive strength. FIG. 5B presents the compressive strength results for BioCs mortar specimens. The results of mortar mix with BioCs biochar were broadly like those with BioCl mixes, as illustrated in FIG. 5A. Although the incorporation of BioCs showed an increase in compressive strength compared to the control mortar, the BioCs mix depicted lower strengths at all ages compared to BioCl mortar. This is due to the high porosity, roughness, and ash content of BioCl biochar than BioCs [Constr Build Mater, 2021, 283:122757, which is incorporated herein by reference in its entirety]. Adding 0.75% BioCs biochar improved the compressive strength by 3-5% because of a better cement hydration rate. Hence, it can be concluded that a 0.75% addition of BioCl and 1.00% of BioCs can be treated as an optimum dosage of biochar materials from the perspective of compressive strength.

### Example 7: Influence of Biochar on the Volume of Permeable Voids

Referring to FIG. 6 illustrating the volume of permeable voids (VPV) of the mortar mixes, evidence shows that 0.25% BioCl, 0.5% BioCl, and all the mixes of BioCs specimens have comparable VPV within a 1-2.5% increment to the control specimen. The specimen with 0.75% and 1% of BioCl has the lowest VPV of 10.3% and 8.2%, respectively. In general, the permeability is lower among the biochar-added specimens compared to the control mix. All the specimens owing BioCl exhibit slightly lower voids percentage compared to BioCs reinforced mortar specimens. This is primarily due to the pozzolanic reaction, capillary pores, higher water retention capacity, and particle sizes [Constr Build Mater, 2020, 234:117338, which is incorporated herein by reference in its entirety]. The mortar matrix of BioCl mixes is denser than that of BioCs, resulting in less voids and subsequently less absorption of water that ultimately prohibits the creation of dense structure, as commonly observed in numerous literature [Sci Total Environ, 2018 616-617:408-416 & Sci Total Environ, 2021, 750:142327, which is incorporated herein by reference in its entirety].

### Example 8: Ultrasonic Pulse Velocity Testing

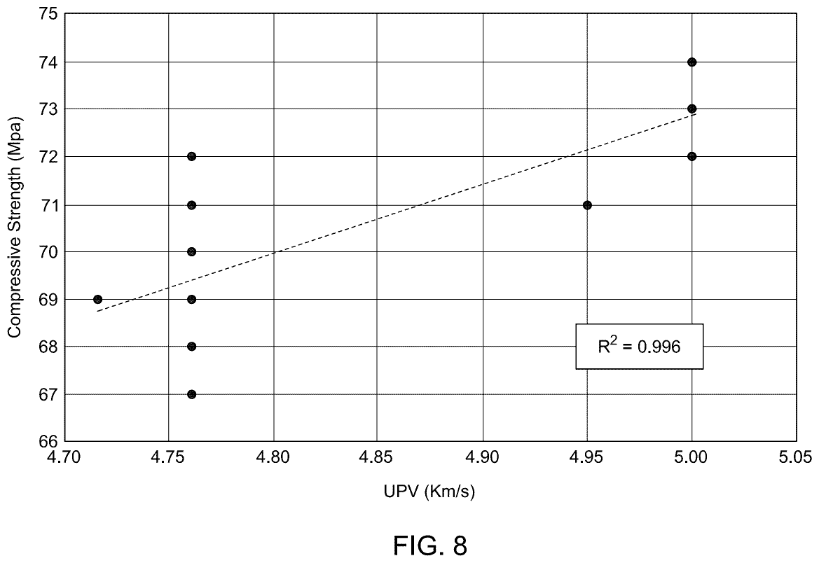

Referring to FIG. 7 which presents the ultrasonic pulse velocity (UPV) testing results for the control mortar specimen along with BioCl and BioCs. The values of UPV ranged between 4.76 and 5 km/s, with an average of 4.86 km/s. However, the BioCl samples depicted higher UPVs than the BioCs samples, while both biochar-based mortar samples depicted higher average UPV than control mortar. The improvement in UPV biochar-based mortar implies the pozzolanic activity due to the presence of biochar. Interestingly, UPV values for all biochar-based mortar specimens were found above 4.76 km/s, and the mortar's quality could be deemed “excellent” as per IS: 13,311 (part1)—1992 standards. The mortar with such UPV values can be termed as strong, with fewer voids and cracks, resulting in better structural integrity and quality [Mater Today Proc, 2021 42:1422-1431 & Appl Geophys, 2017,141:13-23, which is incorporated herein by reference in its entirety]. Note that a good correlation exists between UPV and compressive strength results with the R2 value of 0.9996, indicating that the growth in compressive strength was recorded for the reinforced specimens, as depicted in FIG. 8. Results showed cement may be replaced with various mineral powder materials in the proportion of 0%, 10%, and 30% [Constr Build Mater, 2020, 258:119550, which is incorporated herein by reference in its entirety]. However, other factors can affect the UPV value, such as internal voids, micro-cracking and segregation etc. [Constr Build Mater, 2018, 171:511-520; Mater Today Proc, 2020, 27:1111-1117.; J Build Eng, 2020, 27:100949; Case Stud Constr Mater, 2021 15: e00761, each of which is incorporated herein by reference in its entirety]. These are investigated in detail in the present disclosure as described below with samples exposed to external loading and relating the UPV to the internal crack initiation and propagation.

### Example 9: Non-Destructive Testing (NDT) and Crack Propagation Mechanism

The use of NDT to identify the location, origin, branching, crack bridging, and extension of internal micro-cracks in reinforced concrete members is disclosed [Case Stud Constr Mater, 2021 15: e00761; Struct Concr, 2021, 22:2849-2867; J Build Eng, 2021, 30:101260; Constr Build Mater, 2018, 180:364-374; J Mater Civ Eng, 2018, 30:4018023; Constr Build Mater, 2021, 290:123256.; Struct Eng Mech, 2018, 65:601-609, each of which is incorporated herein by reference in its entirety]. In this regard, one of the objectives of the examples of the present disclosure is to employ the NDT technique to identify internal flaws in the biochar mortar. For this purpose, biochar mortar samples, i.e., BioCl and BioCs, were divided into five proportions with regard to the addition of the biochar proportion in the mix. The mix percentages investigated in the presented research work consist of 0.25, 0.50, 0.75, 1.00, and 1.50 wt % biochar. Ten variations of BioCl and BioCs combinations were evaluated using direct and indirect evaluation methods. Another objective of the examples provided in the present disclosure was to assess the effects of varying biochar material on the UPV and identify internal microcracking at the interfacial transition zone (ITZ) of FA in a mortar as shown in Tables 4 to 10 [Aziz, Muhammad & Zubair, Mukarram & Saleem, Muhammad & Alharthi, Yasir & Ashraf, Noman & Alotaibi, Khalid & Aga, Omer & Eid, Ammar. (2023). Mechanical, non-destructive, and thermal characterization of biochar-based mortar composite. Supplementary file. Biomass Conversion and Biorefinery, which is incorporated herein by reference in its entirety].

TABLE 4
Percentage reduction in UPV values for BioCl and BioCs mortar
tested via direct methods of assessment with 1.00 wt % Biochar

| BioChar | Control | F_{comp} | | % age |
|---|---|---|---|---|
| % Age | Average | % age | ΔV | Reduction |
| 1.00 | 3779.91 | 20.00% | 3704 | 2.01 |
| BioCl | | 40.00% | 3677 | 2.73 |
| | | 60.00% | 3623 | 4.15 |
| | | 80.00% | 3584 | 5.18 |
| 1.00 | 3993.62 | 20.00% | 3704 | 7.25 |
| BioCs | | 40.00% | 3663 | 8.28 |
| | | 60.00% | 3623 | 9.28 |
| | | 80.00% | 3534 | 11.52 |

TABLE 5
Percentage reduction in UPV values for BioCl and BioCs mortar
tested via direct methods of assessment with 1.25 wt % Biochar

| BioChar | Control | F_{comp} | | % age |
|---|---|---|---|---|
| % Age | Average | % age | ΔV | Reduction |
| 1.50 | 3634.99 | 20.00% | 3572 | 1.74 |
| BioCl | | 40.00% | 3559 | 2.10 |
| | | 60.00% | 3402 | 6.42 |
| | | 80.00% | 3290 | 9.50 |
| 1.50 | 3575.11 | 20.00% | 3509 | 1.85 |
| BioCs | | 40.00% | 3300 | 7.68 |
| | | 60.00% | 2967 | 17.00 |
| | | 80.00% | 2882 | 19.39 |

TABLE 6
Percentage reduction of UPV for for BioCl
and BioCs at 0.25% by in-direct method

| Biochar | Control | F_{comp} | | % age |
|---|---|---|---|---|
| % Age | Average | % age | ΔV | Reduction |
| 0.25 | 9938.43 | 20.00% | 8279 | 16.70 |
| BioCl | | 40.00% | 8477 | 14.70 |
| | | 60.00% | 7939 | 20.12 |
| | | 80.00% | 7814 | 21.37 |
| 0.25 | 11076.02 | 20.00% | 10990 | 0.77 |
| BioCs | | 40.00% | 10754 | 2.91 |
| | | 60.00% | 9525 | 14.01 |
| | | 80.00% | 8333 | 24.76 |

TABLE 7
Percentage reduction of UPV for BioCl
and BioCs at 0.50% by in-direct method

| Biochar | Control | F_{comp} | | % age |
|---|---|---|---|---|
| % Age | Average | % age | ΔV | Reduction |
| 0.50 | 8812.53 | 20.00% | 8199 | 6.96 |
| BioCl | | 40.00% | 7634 | 13.37 |
| | | 60.00% | 7095 | 19.48 |
| | | 80.00% | 6950 | 21.14 |
| 0.50 | 10039.48 | 20.00% | 9804 | 2.35 |
| BioCs | | 40.00% | 9437 | 6.00 |
| | | 60.00% | 8856 | 11.79 |
| | | 80.00% | 8199 | 18.33 |

TABLE 8
Percentage reduction of UPV for BioCl
and BioCs at 0.75% by in-direct method

| Biochar | Control | F_{comp} | | % age |
|---|---|---|---|---|
| % Age | Average | % age | ΔV | Reduction |
| 0.75 | 7472.66 | 20.00% | 7355 | 1.58 |
| BioCl | | 40.00% | 7248 | 3.01 |
| | | 60.00% | 6851 | 8.32 |
| | | 80.00% | 6370 | 14.76 |
| 0.75 | 9649.38 | 20.00% | 9353 | 3.07 |
| BioCs | | 40.00% | 9181 | 4.85 |
| | | 60.00% | 8553 | 11.37 |
| | | 80.00% | 8001 | 17.09 |

TABLE 9
Percentage reduction of UPV for for BioCl
and BioCs at 1.00% by in-direct method

| Biochar | Control | F_{comp} | | % age |
|---|---|---|---|---|
| % Age | Average | % age | ΔV | Reduction |
| 1.00 | 6911.06 | 20.00% | 6851 | 0.87 |
| BioCl | | 40.00% | 6803 | 1.56 |
| | | 60.00% | 6372 | 7.80 |
| | | 80.00% | 6290 | 8.99 |
| 1.00 | 8321.82 | 20.00% | 8199 | 1.48 |
| BioCs | | 40.00% | 8001 | 3.86 |
| | | 60.00% | 7752 | 6.84 |
| | | 80.00% | 7576 | 8.97 |

TABLE 10
Percentage reduction of UPV for for BioCl
and BioCs at 1.50% by in-direct method

| Biochar | Control | F_{comp} | | % age |
|---|---|---|---|---|
| % Age | Average | % age | ΔV | Reduction |
| 1.50 | 6541.51 | 20.00% | 6372 | 2.60 |
| BioCl | | 40.00% | 6135 | 6.21 |
| | | 60.00% | 6098 | 6.77 |
| | | 80.00% | 5714 | 12.64 |
| 1.50 | 7905.86 | 20.00% | 7694 | 2.68 |
| BioCs | | 40.00% | 7519 | 4.89 |
| | | 60.00% | 7300 | 7.67 |
| | | 80.00% | 7093 | 10.29 |

Additionally, note the control values of UPV for BioCl and BioCs specimens, respectively, before applying the applied load. These readings are referred to as control conditions from here onwards for ease of understanding. The control condition readings are compared with UPV readings noted after loading the samples to identify delays in the UPV for the fixed path length. UPV for the constant path length decreased as applied loading increased and was utilized to identify the internal cracking in concrete members [Constr Mater, 2021 15: e00761; Struct Concr, 2021, 22:2849-2867; J Build Eng, 2021, 30:101260; Constr Build Mater, 2018, 180:364-374; J Mater Civ Eng, 2018, 30:4018023; Constr Build Mater, 2021, 290:123256, each of which is incorporated herein by reference in its entirety]. For this purpose, the ten BioCl and BioCs mortar samples were tested under compressive loading to establish the final load strength as Fcomp using ASTM C109/C109M standard [Annu B ASTM Stand, 2018, 04:1-10, which is incorporated herein by reference in its entirety]. The average compressive load carrying strength of 71.9 MPa and 70.1 MPa was recorded for BioCl and BioCs mortar, respectively. Subsequently, gradually increasing loading was applied on each BioCl and BioCs mortar sample, with UPV reading taken after every increased load application. The loading was applied in gradual increments of 20%, 40%, 60%, and 80% of the Fcomp to 30 biochar specimens (2 biochar types with five biochar. proportions having three specimens per test). After each application of external load, UPV reading was recorded. Extreme care was practiced in recording the UPV reading to eradicate any human error induced owing to the holding pressure of the transducer and receiver, air bubbles in the gel, proper attachment, etc. The UPVs for each BioCl and BioCs mortar specimen under increasing external loading tested by the direct and indirect evaluation methods.

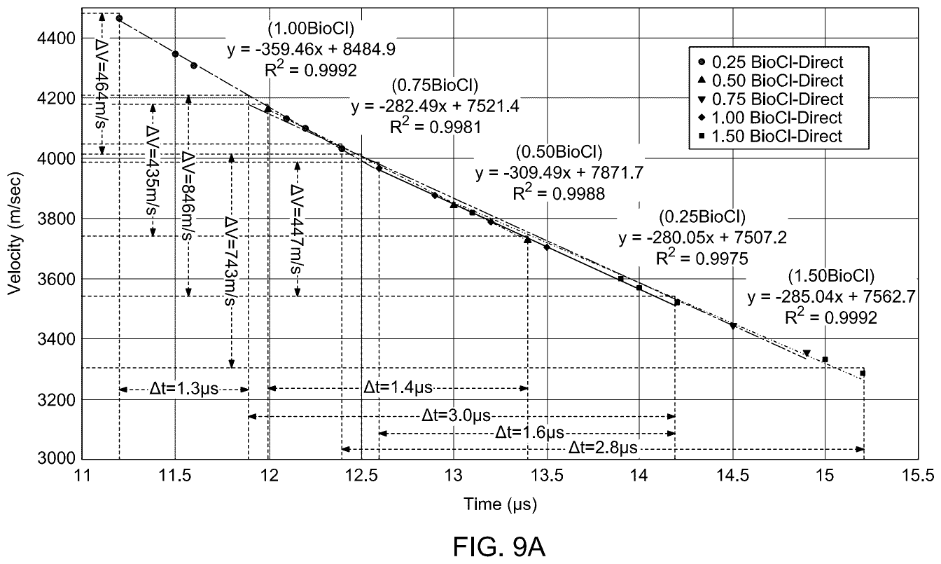

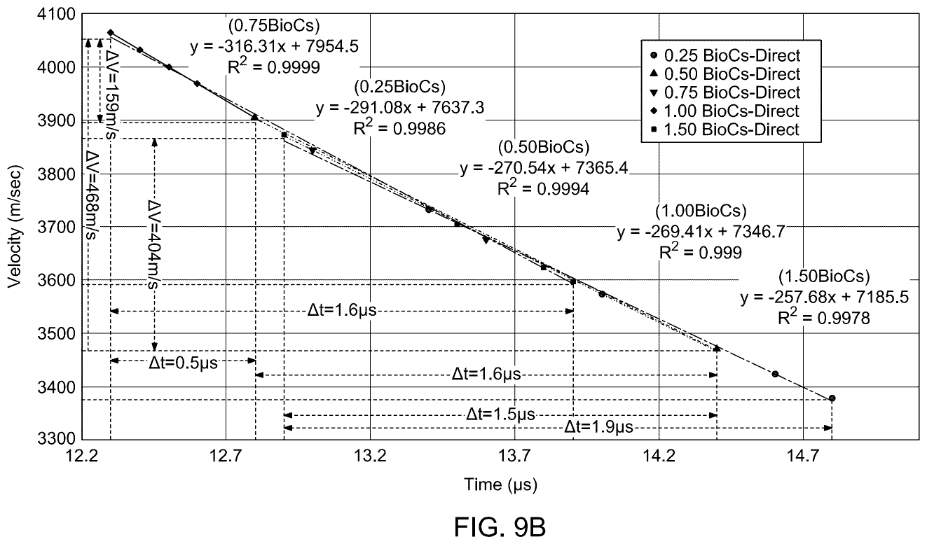

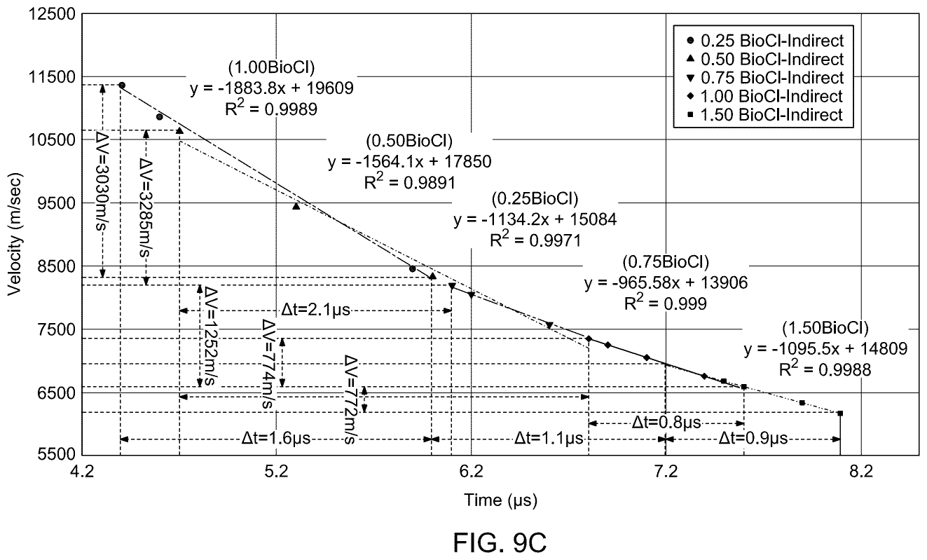

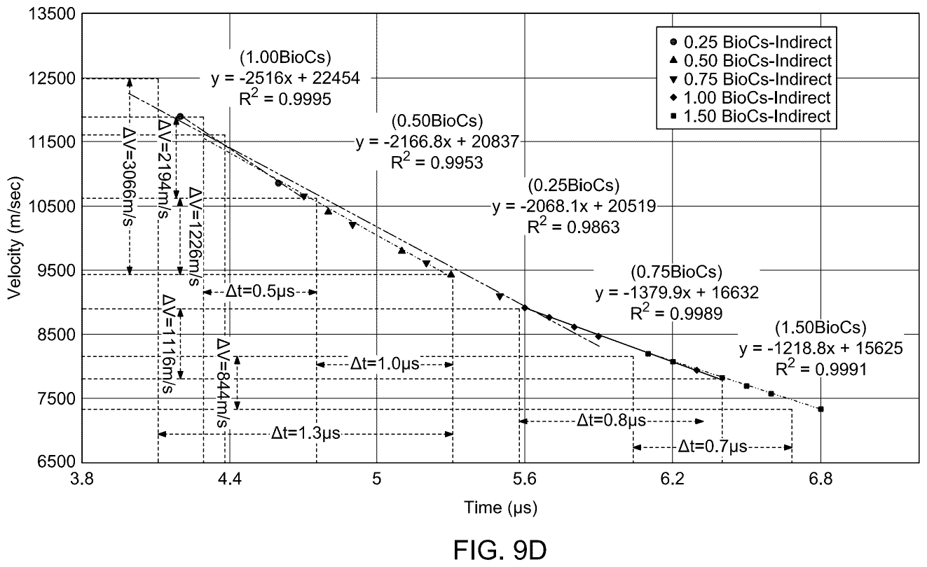

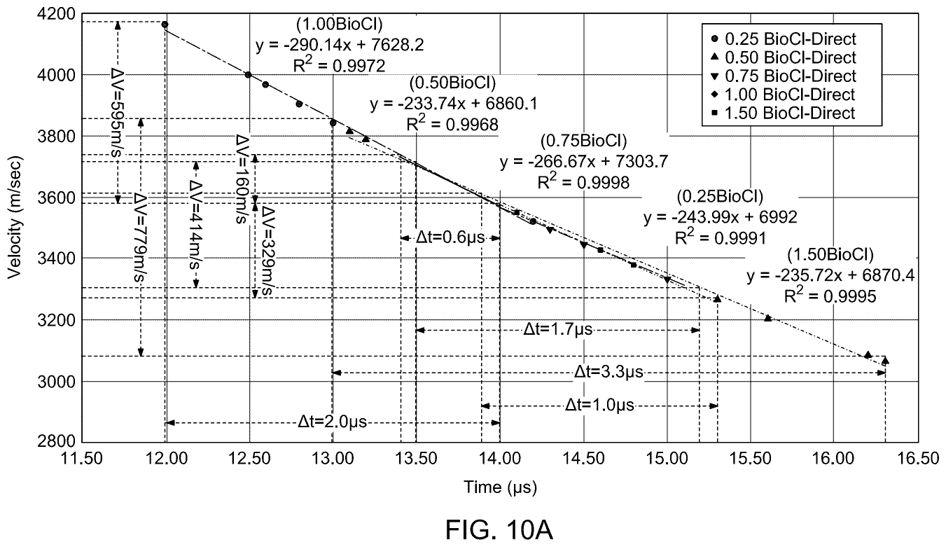

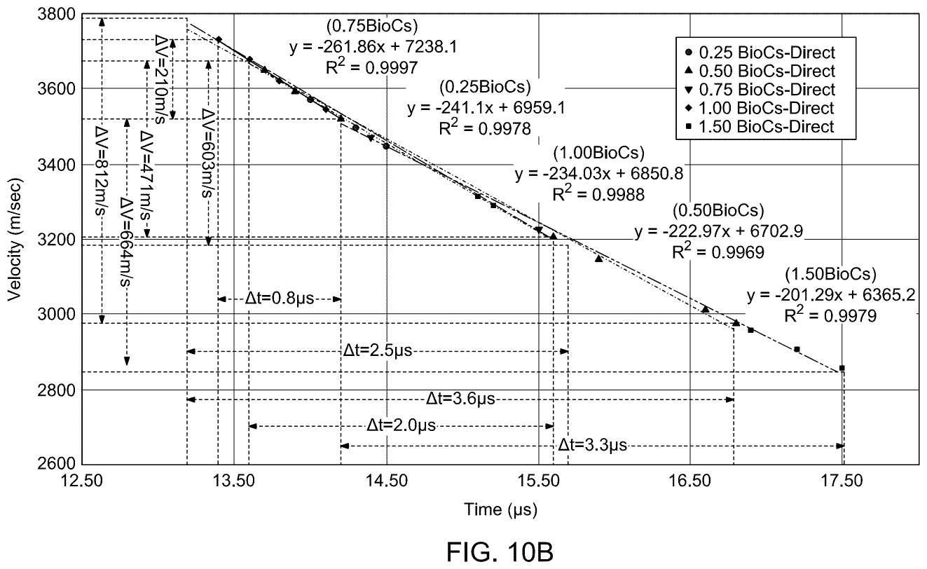

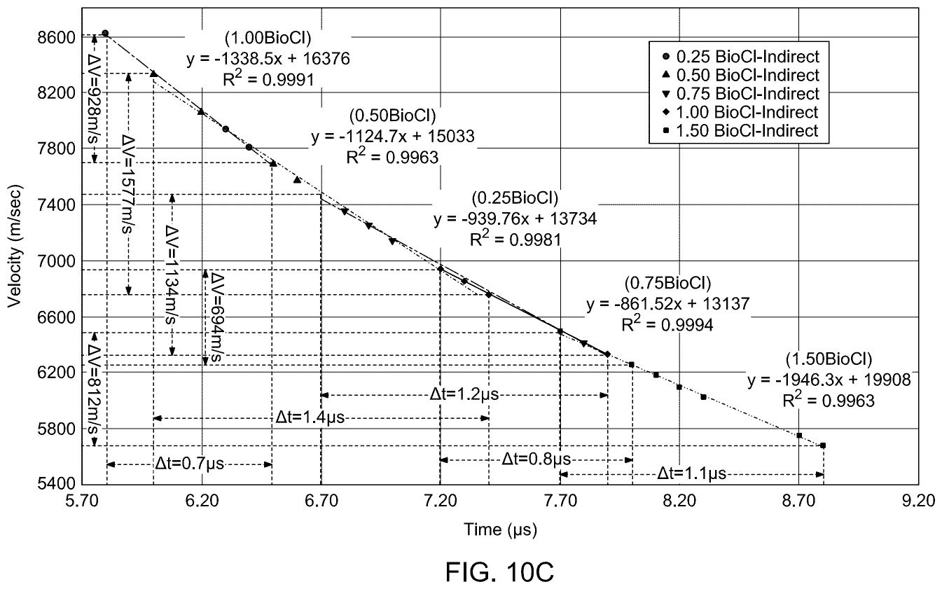

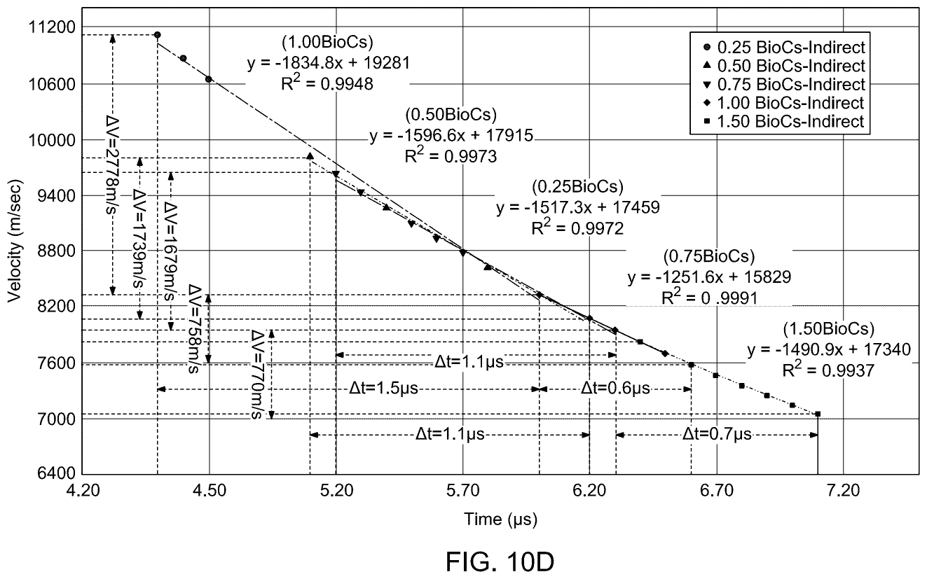

FIG. 9A to FIG. 9D present the experimental results of NDT under control condition, i.e., before the application of external load. The vertical axis presents the UPV in (m/s), and the horizontal axis illustrates the time taken by the ultrasonic pulse to travel along the width of the specimen in (us) for each of the BioCl, and BioCs mortar specimens, respectively. The provided experimental evidence shows that the UPV increased as the proportion of biochar in the mortar increased. This is illustrated by the shorter time it took, represented by increased wave velocity in direct and indirect measurements. FIG. 10A to 10D depict the UPVs as a function of time for each BioCl and BioCs mortar specimen. The results showed that the UPV decreased after the application of external incremental loading. This reduction in UPV can be linked to the origination, bridging, and extension of internal micro-cracks at the interfacial transition zone (ITZ) of the biochar-based mortar specimens. From the results of experimentation, BioCl samples depicted a lower reduction in UPV than BioCs mortar. Furthermore, the smaller reduction was recorded in 0.75 BioCl. Additional experimentation for the reduction in UPV for BioCl, and BioCs for direct and indirect testing for 0.25, 0.50, 0.75, 1.00, and 1.50 wt % biochar, respectively, indicate that the UPV decreased, owing to an increase of externally applied loading, a phenomenon due origination, bridging, and extension of microcracks [Constr Build Mater, 2021, 290:123256; Annu B ASTM Stand, 2018, 04:1-10; Struct Eng Mech, 2017, each of which is incorporated herein by reference in its entirety]. In addition, an observation during experimentation is that the UPVs varied with the proportion of biochar. Furthermore, the experimental results for UPV tested using the direct method of investigation for 0.25, 0.50, 0.75, 1.00, and 1.50 wt. % biochar revealed that the UPV reduced by 16.4%, 22.5%, 13.1%, 5.2%, and 9.5% respectively after the application of 80% of the F_{comp}. The reductions in UPV in percentages for the BioCs mortar specimens under similar conditions were 12.90, 20.46, 16.40, 11.52, and 19.39%. Similar identical trends were recorded from the analysis of experimental data related to readings obtained using indirect testing methods. According to these collective results, the UPV decreased as the applied external loading increased along the same path. The presented experimental results show that 0.75% and 1.00% is the optimal dosage for BioCl mortar, while 1.00% is the optimal dosage for BioCs mortar. The variation in reduction of the UPV owing to the varying type of biochar inclusion is due to the dense packing of biochar particles into the interfacial transition zone. Furthermore, since the biochar material is discretely shaped, sharp edges are observed in BioCs material, while rounded edges are observed in BioCl material. Hence, the rounded particles can densely pack the mortar and fill in the gaps left in between, resulting in a high density, hence leading to a larger load-carrying capacity owing to the increased energy demand for crack growth, interlinking, and propagation in dense mortar. However, for BioCs material as the material is sharp, the dense packing of nano spaces was not as effective. Thus, cracking could travel more quickly compared to BioCl mortar, thus leading to lower load-carrying capacity, as observed and recorded in the experimentation. Therefore, the BioCl material is more suitable for application in mortar than BioCs material with 0.75% as the optimum dosage of biochar material in the developed mortar.

### Example 10: Thermal Conductivity of BioCl and BioCs Biochar-Based Masonry Concrete Blocks

Thermal cracking and latent heat produced by the hydration reaction are major challenges for construction engineers. Much effort has been expended to overcome the difficulties associated with the heat of hydration in concrete and its effects on high-performance concrete materials. In this regard, the carbon-rich biochar material presents an essential breakthrough for thermal management of its ability to store heat. Hence, one of the objectives of the present examples was to perform a detailed thermal analysis and experimental studies to examine the effect of date palm-based biochar, namely BioCl and BioCs, on the thermal characteristic of the masonry concrete blocks dedicated for construction purposes. The thermal conductivity of the concrete blocks was determined under steady-state circumstances using a heat flow meter that complies with the ASTM C518 [ASTM Int., 2015, C518-15], JIS A1412, ISO 8301, and DIN EN 12,667 standards [JIS A 1412-1, Japanese Standards Association (JSA); Macromol Mater Eng, 2019, 304:4; Saudi Building Code (SBC), 2022, 601/602 Saudi Arabia. Materials (Basel) 15, each of which is incorporated herein by reference in its entirety]. Reference is now made to FIG. 10 and FIG. 11 which show the variation in thermal conductivity with uncertainties of the developed concrete blocks as a function of biochar content and the control block. The thermal property of the control concrete block (OPC) is similar to those of a standard masonry block [Mater Renew Sustain Energy, 2020, which is incorporated herein by reference in its entirety]. The decrement in conductivity was recorded with the addition of biochar. The 0.25% and 1.5% BioCl samples had thermal conductivity values ranging from 0.53 W/mK to 0.78 W/mK, while the control sample had a value of 0.85 W/mK. [Appl Therm Eng, 2009, 29:1123-1130, which is incorporated herein by reference in its entirety]. Further, the thermal properties of the BioCs-based concrete masonry blocks were slightly decreased when compared with the proportional addition of BioCl biochar to the concrete masonry blocks. The reduction of 11%, 19%, 26%, 33%, and 41% in thermal conductivity was recorded when the OPC was loaded with 0.25, 0.5, 0.75, 1%, and 1.5% BioCl, respectively, for the modified blocks.

As indicated above, FIG. 12 illustrates the decreasing trend in thermal conductivity of the concrete blocks with the increase in biochar content, enhancing the thermal insulation performance, assessed at 38% for the block containing 1.5% of BioCs compared to thermal conductivity of 0.53 W/mK, that is far smaller than that of control block whose thermal conductivity is equivalent to 0.85 W/mK. There are several explanations for the reduction in thermal conductivity. First is the porous nature of the biochar (BioCl and BioCs), whose pores are much smaller. Secondly, due to the steadily increasing amount of biochar whose thermal conductivity is substantially smaller these outcomes advance the thermal insulation of developed concrete blocks. The thermal conductivity for the cement matrix stabilized using lime was observed to have a minimum value of 0.51 W/mK. The high void percentage increases the volume of trapped air and subsequently enhances thermal efficiency and account for the low thermal conductivity value of biochar-based blocks.

The method of the present disclosure include sequestering and fixation of CO₂ to reduce the greenhouse gas emissions reducing the overall impact of the cement industry on the environment. Another advantage of the present composition is that the composition is sustainable, environmental-friendly, cost-effective, and easy to produce at industry level.

One of the features of the present disclosure include improving the compressive strength of the cement. Another feature of the present composition is the enhancement of the mechanical properties of the cement and mortar. Yet another feature is the improvement in the hydration properties of the cement once the composition of the present disclosure is added to the cement or mortar. Another feature of the present disclosure is the cement is curable. Thus, the cement of the present disclosure has improved mechanical, thermal properties. Other features include but are not limited to improved moisture retention, viscosity, and volume stability. The cement of the present disclosure is resistant to freezing, thawing and extreme hot conditions. Another feature of the cement of the present disclosure is resistance to scaling and abrasions.

Numerous modifications and variations of the present disclosure are possible in light of the above teachings. It is therefore to be understood that within the scope of the appended claims, the invention may be practiced otherwise than as specifically described herein.

1: A cement composition, comprising:
a cementitious material in an amount of 10 to 40 wt. % based on a total weight of the cement composition;
a date palm biochar in an amount of 0.25 to 1.5 wt. % based on a total weight of the cementitious material;
a fine aggregate (FA) in an amount of 20 to 85 wt. % based on the total weight of the cement composition;
a coarse aggregate (CA) in an amount of 0.01 to 60 wt. % based on the total weight of the cement composition;
a plasticizer in an amount of 0.001 to 2 wt. % based on the total weight of the cement composition;
wherein the date palm biochar has a particle size in a range of 0.1 to 20 micrometers (μm);
and wherein the date palm biochar is at least one of a date palm leaves biochar (BioCl), and a date palm seeds biochar (BioCs).

2: The cement composition of claim 1, wherein the date palm biochar is in the form of BioCl particles, and wherein the BioCl particles are in the form of flake particles and circular particles having a rough surface morphology.

3: The cement composition of claim 2, wherein the BioCl particles have an average particle size of 1 to 12 μm.

4: The cement composition of claim 2, wherein the BioCl particles have an ash content of 20 to 30 wt. % as determined by ASTM D1506.

5: The cement composition of claim 1, wherein the date palm biochar is in the form of BioCs particles, and wherein the BioCs particles are plate-like particles having a smooth surface morphology.

6: The cement composition of claim 5, wherein the BioCs particles have an average particle size of 1 to 15 μm.

7: The cement composition of claim 5, wherein the BioCs particles have an ash content of 15 to 25 wt. % as determined by ASTM D1506.

8: The cement composition of claim 1, wherein the cementitious material comprises at least one selected from the group consisting of portland cement, pozzolan cement, gypsum cement, aluminous cement, silica cement, and alkaline cement.

9: The cement composition of claim 1, wherein the cementitious material is type I ordinary portland cement (OPC), and wherein the OPC has a standard specification of ASTM C150.

10: The cement composition of claim 1, wherein the fine aggregate has a specific gravity of 2.2 to 2.8, and a standard specification of ASTM C128.

11: The cement composition of claim 1, wherein the coarse aggregate has a specific gravity of 2.2 to 2.8, and a maximum particle size of at most 20 mm.

12: The cement composition of claim 1, wherein the plasticizer comprises at least one selected from the group consisting of a lignosulfonate plasticizer, a polycarboxylate ether plasticizer, a melamine plasticizer, and a naphthalene plasticizer.

13: A method of producing a cured specimen, the method comprising:
mixing the cement composition of claim 1 with water to form a mortar composition;
casting the mortar composition in a mold to form a molded composition; and
curing the molded composition for 0.5-120 days thereby forming the cured specimen.

14: The method of claim 13, wherein the water is at least one selected from the group consisting of tap water, ground water, distilled water, deionized water, fresh water, and desalted water.

15: The method of claim 13, wherein the mortar composition has a flowability of 170 to 230 millimeters (mm) as determined by ASTM C1437/C230

16: The method of claim 13, wherein the cured specimen has a compressive strength of 50 to 80 MPa as determined by ASTM C109/C109M.

17: The method of claim 13, wherein the cured specimen has a volume of permeable voids (VPV) of 6 to 12% by volume as determined by ASTM C642-13.

18: The method of claim 13, wherein the cured specimen has an ultrasonic pulse velocity (UPV) of 3 to 6 kilometers per second (km/s) as determined by ASTM C 597.

19: The method of claim 13, wherein the cured specimen has a thermal conductivity of 0.3 to 1 watts per meter-kelvin (W/mK) as determined by ASTM D7984 and ISO 22,007-2.

20: A method for sequestering carbon by incorporating date palm biochar in a cement composition, comprising:
heating a date palm material to a temperature of 500 to 700° C. at a heating rate of 5 to 20 degrees Celsius per minute (° C./min) to form the date palm biochar;
wherein the date palm biochar has an average particle size in a range of 0.5 to 20 μm, wherein the date palm material is at least one of date palm leaves and date palm seeds;
mixing the date palm biochar, a cementitious material, a fine aggregate, a coarse aggregate, and a plasticizer to form the cement composition;
wherein the cement composition is curable.
